(19) United States
(12) Patent Application Publication
(10) Pub. No.: US 2017/0199930 A1
(43) Pub. Date: Jul. 13, 2017

(54) Systems Methods Devices Circuits and Associated Computer Executable Code for Taste Profiling of Internet Users

(71) Applicant: JINNI MEDIA LTD., Hod HaSharon (IL)

(72) Inventors: Yohai Trabelsi, Ashkelon (IL); Mordechai Mori Rimon, Jerusalem (IL); Izhak Ben-Zaken, Shimshit (IL); Ori Assaraf, Hod HaSharon (IL)

(21) Appl. No.: 15/466,973

(22) Filed: Mar. 23, 2017

Related U.S. Application Data
(63) Continuation-in-part of application No. 13/872,115, filed on Apr. 28, 2013.
Application No. 13/872,115 is a continuation-in-part of application No. 12/859,248, filed on Aug. 18, 2010.
(60) Provisional application No. 62/333,291, filed on May 9, 2016.
(60) Provisional application No. 61/234,817, filed on Aug. 18, 2009.

(51) Int. Cl. G06F 17/30

(52) U.S. Cl. CPC G06F 17/30684; G06F 17/30867; G06F 17/30625; G06F 17/3069

(57) ABSTRACT

Disclosed are systems, methods, devices, circuits, and associated computer executable code for taste profiling of internet or network users. A User Events Analysis Server filters out vast amounts of irrelevant data, hard to isolate in conventional methods, and extracts valuable data from web-browsing or networking events. A User Taste Profiling Server automatically generates domain specific (e.g. media content) semantic taste profiles for users associated with the filtered and extracted web-browsing or networking events. Among other applications, such taste profiles may facilitate effective targeting of advertising campaigns in the given content domain.

### RELATED APPLICATIONS

This application claims the priority of applicant's U.S. Provisional Patent Application No. 62/333,291, filed May 9, 2016. This application is also a continuation-in-part of applicant's U.S. patent application Ser. No. 13/872,115, filed Apr. 28, 2013, which is a continuation-in-part of U.S. patent application Ser. No. 12/859,248, filed Aug. 18, 2010, which claims priority from U.S. Provisional Patent Application No. 61/234,817, filed Aug. 18, 2009. The disclosures of all of the above mentioned: Ser. Nos. 62/333,291, 13/872,115, 12/859,248 and 61/234,817 patent applications, are hereby incorporated by reference in their entirety for all purposes.

### FIELD OF THE INVENTION

The present invention generally relates to the fields of Online Behavioral Analysis and Internet User Profiling, and more particularly, to systems, methods, devices, circuits, and associated computer executable code for domain-specific Taste Profiling of Internet Users.

### BACKGROUND

E-commerce and marketing firms have taken advantage of profiling for years by collecting volumes of information on individuals. Such profiling is accomplished by aggregating information on individuals purchase history (online and offline), finance records, magazine sales, supermarket savings cards, surveys, and sweepstakes entries, just to name a few. This information is then cleaned, organized, and analyzed using a number of statistical and data mining techniques to create a “shopping” profile of that individual. These profiles can then be used to target ad campaigns, personalize a shopping experience, or make recommendations on additional products a user may find appealing.

A range of technologies and techniques used by online website publishers and advertisers are aimed at increasing the effectiveness of advertising using user web-browsing behavior information. Information is collected from an individual's web-browsing behavior (e.g. the pages that they have visited or searched) to match content or select advertisements to display.

When a user visits a web site, the pages they visit, the amount of time they view each page, the links they click on, the searches they make and the things that they interact with, allow sites to collect that data, and other factors, create a ‘profile’ that links to that visitor (e.g. to visitor's web browser). This type of data may be used to create defined audience segments based upon visitors having substantially similar profiles, wherein defined audience segments may be utilized for targeted advertising.

Targeted advertising is a type of advertising whereby advertisements are placed so as to reach consumers based on various traits such as demographics, psychographics, behavioral variables (such as product purchase history), or other second-order activities which serve as a proxy for these traits.

Most targeted new media advertising currently uses second-order proxies for targeting, such as tracking online or mobile web activities of consumers, associating historical webpage consumer demographics with new consumer web page access, using a search word as the basis for implied interest, or contextual advertising.

Behavioral targeting is one of the most common targeting methods used online Behavioral targeting works by anonymously monitoring and tracking the content read and sites visited by a user or IP when that user surfs on the Internet. This is done by serving tracking codes. Sites visited, content viewed, and length of visit are databased to predict an online behavioral pattern.

Alternatives to behavioral advertising may include audience targeting, contextual targeting, and psychographic targeting.

The distinctions made by demographic, psychographic and behavioral models, however, are coarse and often fail to predict a fit in some specific domain (e.g. two New Yorkers at their thirty-something years who regularly visit the CNN website, Amazon and Google maps, may still have completely different preferences in movies and TV shows).

Accordingly, there remains a need, in the fields of Online Behavioral Analysis and Internet User Profiling, for solutions facilitating taste-profiling of Internet/Network users, wherein taste-profiling is at least partially based on monitored web-browsing of users, and/or on other type, or combination of types, of monitored user interaction with a computerized device and/or an online/networked computerized device; and the generation of domain specific user taste profiles (e.g. an Entertainment specific taste profile towards movie and TV content).

Such solutions may, for example, facilitate targeted advertising campaigns in the field of Crowd/Audience Targeting, wherein specific crowds/audiences and targeted segments thereof, may be selected and managed at least partially based on generated domain specific (e.g. media content), semantic user taste profiles.

### SUMMARY OF THE INVENTION

According to some embodiments of the present invention, there may be provided systems, methods, devices, circuits, and associated computer executable code for Taste Profiling of Internet or Network Users.

According to some embodiments, semantic domain-specific taste profiles of users may be built based on monitored web, or network, activity of the users. Sets of linguistic items, such as, but not limited to, keywords, phrases and/or multi-word expression(s), extracted from specific web or network user activity events may be used to match at least some of the activity events to corresponding records in a listing of titles and/or entities in the specific domain. Matching records may be used to reference a Structured Taxonomy associated with records in the specific domain and to retrieve from the structured taxonomy degreed semantic features of matched records.

According to some embodiments, a vector may be generated, for each matched activity event, wherein at least some of the value-entries in the generated vector are values of domain-specific degreed semantic features retrieved from the Structured Taxonomy.

According to some embodiments, a tree structured database may be populated with two or more generated vectors associated with the same specific user, wherein each level of the tree, represents a different clustering structure of the specific user associated vectors.

According to some embodiments, an optimal clustering level of the tree structure may be selected as a representation of the semantic taste profile of the specific user, wherein each cluster of vector(s) within the selected clustering level represents a different semantic taste of the specific user.

According to some embodiments of the present invention, a User Events Analysis Server communicatively associated with a web server may extract from one or more web event lines, representing web activities of specific users and received from the web server, sets of linguistic items potentially associated with a specific domain (e.g. entertainment) and register the linguistic items sets to a Keywords/Phrases Data Storage.

a User Semantic Taste Profiling Server may be communicatively associated with: the Keywords/Phrases Data Storage, a records Catalog or Data-store listing content titles or entities in the specific domain and, a Structured Taxonomy of degreed semantic features associated with records in the specific domain.

The User Semantic Taste Profiling Server may: (a) retrieve from the Keywords/Phrases Data Storage and match, at least some of the extracted linguistic items sets, to records (e.g. entertainment titles) in the Catalog or Data-store; (b) generate a vector, for each matched web event, wherein at least some of the value-entries in the generated vector are values of domain-specific degreed semantic features retrieved from the Structured Taxonomy, based on one or more successfully matched Catalog or Data-store records (e.g. entertainment title); (c) populate a tree structured database with two or more generated vectors associated with the same specific user, wherein each level of the tree, represents a different clustering structure of the specific user associated vectors; and/or (d) select an optimal clustering level of the tree structure as a representation of the semantic taste profile of the specific user, wherein each cluster of vector(s) within the selected clustering level represents a different semantic taste of the specific user.

According to some embodiments, the User Events Analysis Server may: (a) utilize content matching techniques to respectively search and find, for each of some or all of the generated linguistic items sets, web-locations containing linguistic items already found in each of the sets; and (b) add to the linguistic items already found in each of the generated sets, additional corresponding linguistic items which appear on the found web-locations associated with each the sets.

According to some embodiments, the User Semantic Taste Profiling Server may: (a) dynamically calculate one or more values based on records (e.g. entertainment titles) in the Catalog or Data-Store; and (b) match at least some of the extracted linguistic items sets to records (e.g. entertainment titles) in the Catalog or Data-Store, at least partially based on matching of the extracted linguistic items sets to the records based dynamically calculated values.

According to some embodiments, the relative level of confidence in the matching of a given linguistic items set to one or more given records (e.g. entertainment title(s)) may be at least partially based on a combination of the following measures of relevance: (a) the matching success history of the given web-domain, which is the source of the linguistic items set currently being matched; (b) positive or negative clues in the text of the URL expression, or the URL linked webpage, associated with the web event from which the linguistic items set, currently being matched, was extracted; and (c) one or more characteristics of candidate titles or entities to which the linguistic items set is currently being matched.

According to some embodiments an initial score may be allocated to each web-domain associated with a web event line from which a linguistic items set has been extracted. Upon a successful matching of a linguistic items set to a specific record (e.g. entertainment title) in the Catalog or Data-store, the score of the web-domain associated with the web event line from which the successfully matched linguistic items set has been extracted may be increased. The relative confidence, in the matching of at least a following linguistic items set to specific records (e.g. entertainment titles) in the Catalog or Data-store, may be estimated considering the increased score of the web-domain, if the same web-domain is also associated with the web event line from which the following set(s) of linguistic items has been extracted.

According to some embodiments, the successful matchings score of specific web-domains may increase, or decrease following to unsuccessful matchings, to represent the successful matching history of linguistic items sets extracted from web events in that domain.

According to some embodiments an initial weight may be allocated to specific linguistic items extracted from the URL string address, or the text within the URL linked webpage, of logged web event lines. Upon a successful matching of a linguistic items set to a specific record (e.g. entertainment title) in the Catalog or Data-store, tuning up the weight(s) of at least some of the specific linguistic items in the set that participated in the successful matching. The relative confidence, in the matching of at least a following linguistic items set to specific records (e.g. entertainment titles) in the Catalog or Data-store, may be estimated considering the tuned up weights of the linguistic items within the following set.

According to some embodiments, tuning up the weight(s) of at least some of the specific linguistic items that participated in the successful matching, may include: setting a similar initial delta value for each of the extracted linguistic items; and, upon a successful matching of a linguistic items set to a specific record (e.g. entertainment title) in the Catalog or Data-store: (a) adding, to the current weight of at least one specific linguistic item that participated in the successful matching, the multiplication of its delta value by its current weight; and (b) updating the delta value of the specific linguistic item that participated in the successful matching, by multiplying it by a pre-defined coefficient, wherein an exemplary selected value of the coefficient may be between 0 and 1.

According to some embodiments, the relative confidence, in the matching of a linguistic items set to specific records (e.g. entertainment titles) in the Catalog or Data-store, may be estimated at least partially based on one or more semantic content characteristics of a specific title or entity record to which the linguistic items set is being matched. The semantic content characteristics of a specific record, to which the linguistic items set is being matched, may be selected from the group consisting of: (a) the length of the matched record, wherein the more words, or characters, are in the record name, the higher the relative confidence in the matching is; (b) the popularity and age of the matched record, wherein the more popular and/or recent a given record is, the higher the relative confidence in the matching is; and/or (c) the statistical term frequencies of the matched record, wherein the lower is the likelihood of the record to be referred to other than as a record in the specific domain, the higher the relative confidence in the matching is.

According to some embodiments, calculating the likelihood of the record to be referred to other than as a record in the specific domain may include: (a) performing a first set of one or more search engine queries, wherein both the record and linguistic items in the specific domain are included in the query; (b) performing a second set of one or more search engine queries, wherein the record with no linguistic items in the specific domain, or the record and linguistic items in a domain(s) other than the specific domain, are included in the query; and (c) calculating a ratio between the average number of search results yielded for the first set of queries and the average number of search results yielded for the second set of queries, wherein the lower the value of the calculated ratio is, the higher likelihood of the record to be referred to other than as a record in the specific domain.

According to some embodiments, the likelihood calculation for at least an additional record may be repeated and a subset of records, having the highest relative likelihood of being referred to as a record in the specific domain, may be selected.

According to some embodiments, populating a tree structured database with vectors, may include: (a) receiving as input a set of event vectors and registering each of the vectors as a leaf in the tree structured database; (b) in each of a set of steps/iterations merging a pair of the most shortly distanced vectors into a single vector, wherein the merged vector consists of a weighted average of its source vectors, and storing the merged vector along with its creation time, and copies of the non-merged vectors, one tree level closer to the root of the tree structured database; and (c) halting the populating of the tree structured database once the distance between the two closest vectors is equal to, or greater than, a predetermined threshold value.

According to some embodiments, selecting an optimal clustering level of the tree structure may include: (a) retrieving or receiving as input, centroid vectors and individual feature vectors, for each of the clusters, of each of the tree structure levels representing a different clustering structure of the specific user associated vectors; (b) utilizing a clustering algorithms evaluation scheme, fed with the retrieved or received inputs, for evaluating the quality of each tree level; and (c) selecting the tree structure level having the highest evaluated quality as the representation of the semantic taste profile of the specific user.

According to some embodiments, populating a tree structured database with vectors, may include: (a) receiving as input a set of event vectors and registering all vectors in the input set, as a single cluster, to the root of the tree structured database; (b) in each of a set of steps/iterations splitting the cluster into two different clusters, and storing the split vectors, along with their creation times, one tree level further away from the root of the tree structure; and (c) halting the populating the tree structured database once the diameter (i.e. distance between vectors in a given cluster) of all vectors clusters, is equal to, or smaller than, a predetermined threshold value. According to some embodiments, as part of splitting a vectors cluster into two different clusters, a K-means algorithm, for example with k=2, may be applied.

According to some embodiments, selecting an optimal clustering level of the tree structure, may include: (a) retrieving or receiving as input, centroid vectors and individual feature vectors, for each of the clusters, of each of the tree structure levels representing a different clustering structure of the specific user associated vectors; (b) utilizing a clustering evaluation metric, such as the Davies-Bouldin index or variations thereof, which favors arrangements with low cluster-internal scatter and high cluster separation, fed with the retrieved or received inputs, for evaluating the quality of each tree level; and (c) selecting the tree structure level having the highest evaluated quality as the representation of the semantic taste profile of the specific user.

According to some embodiments, at least some of the vectors generated for matched web events, may include value-entries representing non-taste relating features. According to some embodiments, non-taste relating features may be selected from a group consisting of: values representing web-surfing habits and available personal user data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1, is a block diagram showing the main modules, components and flow, of an exemplary system for taste profiling of internet users, in accordance with some embodiments of the present invention;

FIG. 2A, is a block diagram showing in further detail the main modules, components and flow, of an exemplary User Event Analysis Server, in accordance with some embodiments of the present invention;

FIG. 2B, is a flowchart showing the steps executed as part of an exemplary process for filtering and extraction of valuable data from browsing events, in accordance with some embodiments of the present invention;

FIGS. 3A-3E, show exemplary data types and structures associated with the steps executed as part of an exemplary process for filtering and extraction of valuable data from browsing events, in accordance with some embodiments of the present invention, wherein:

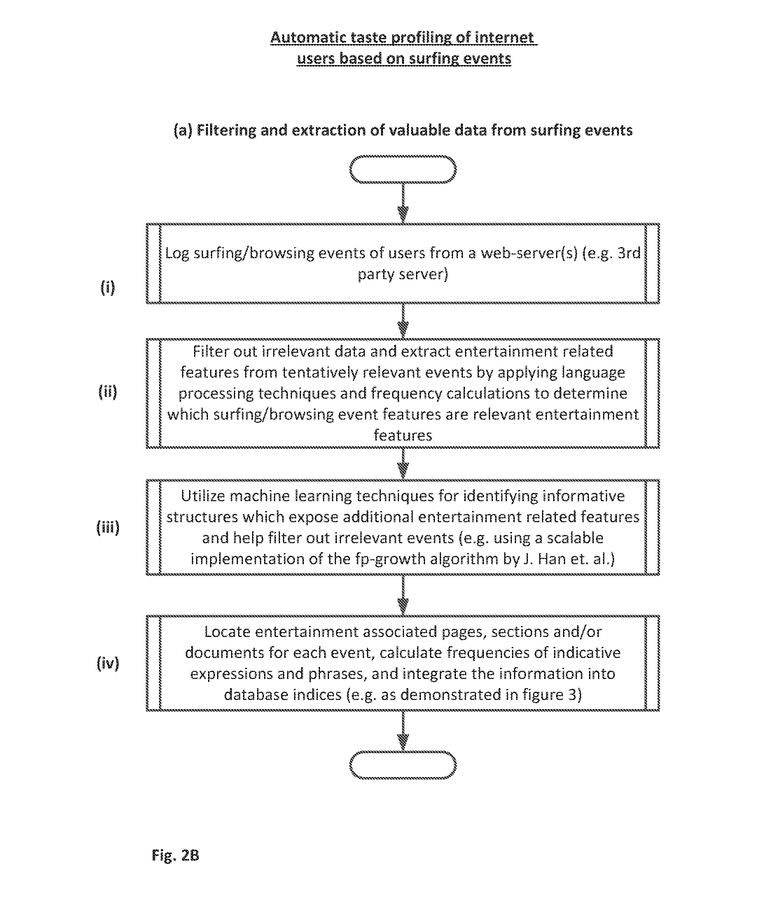

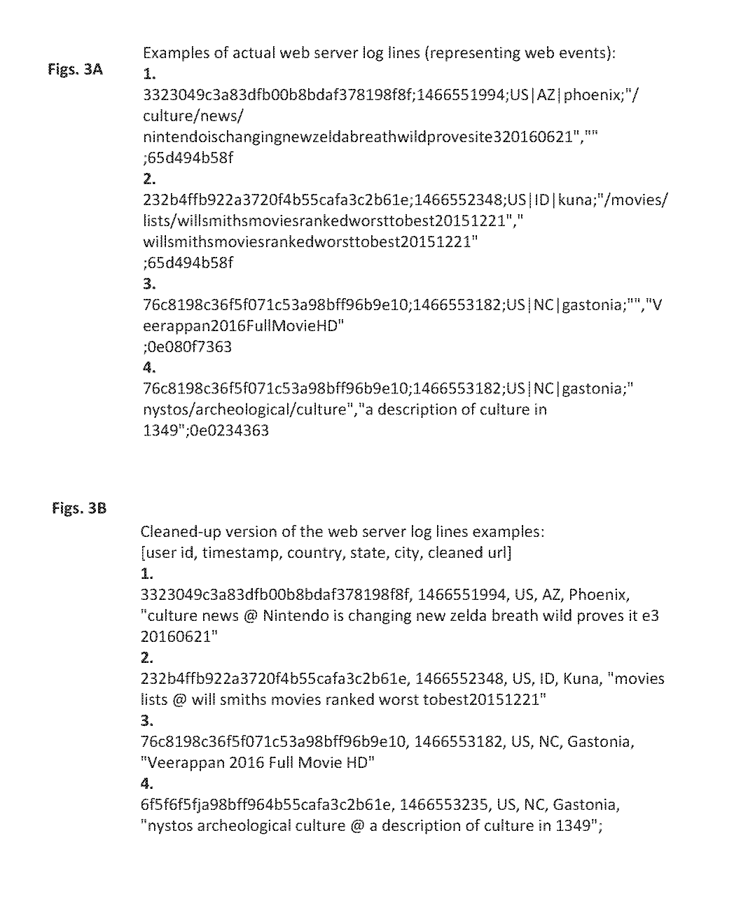

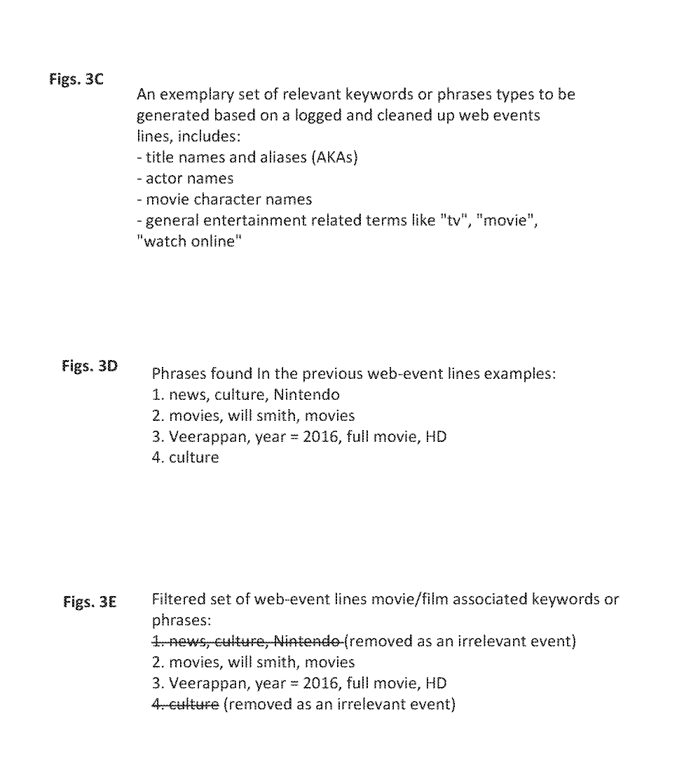

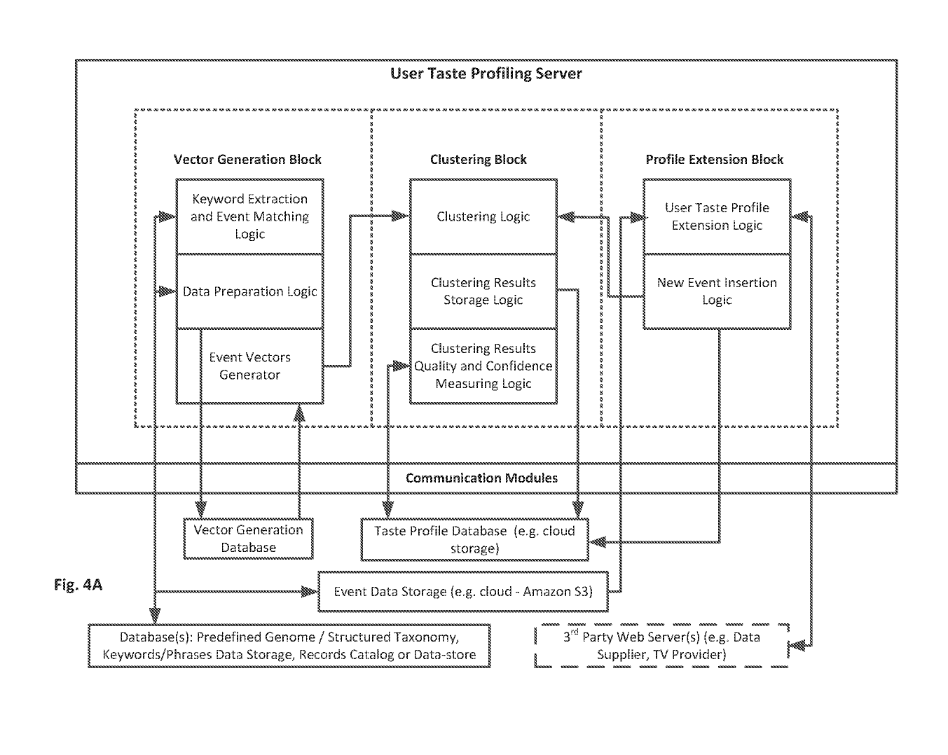

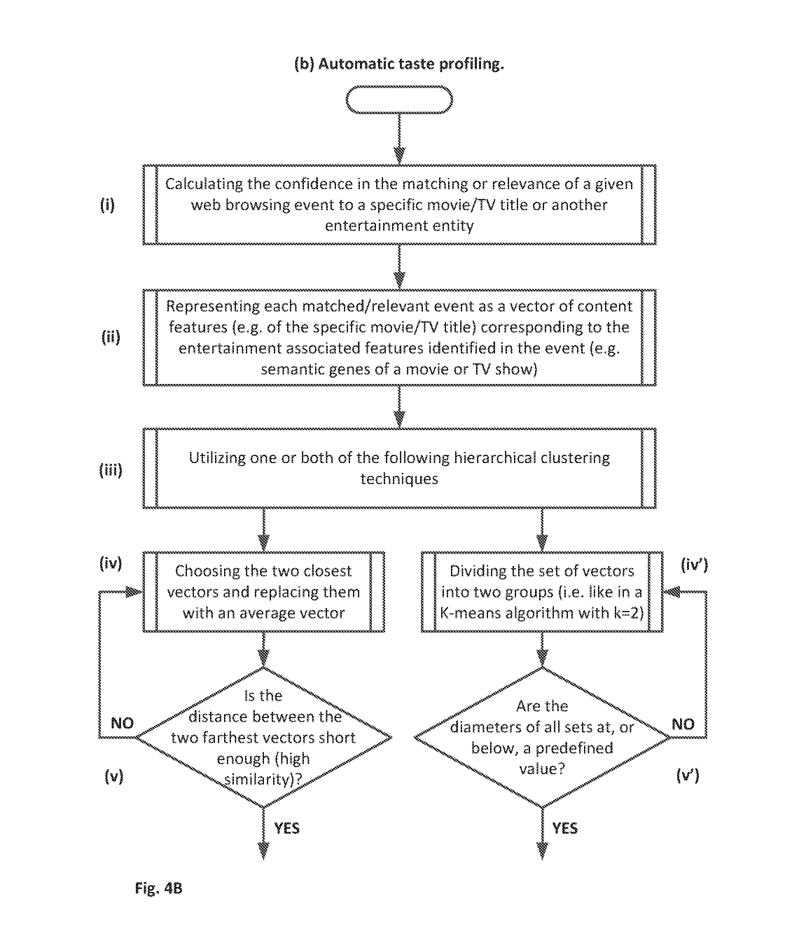

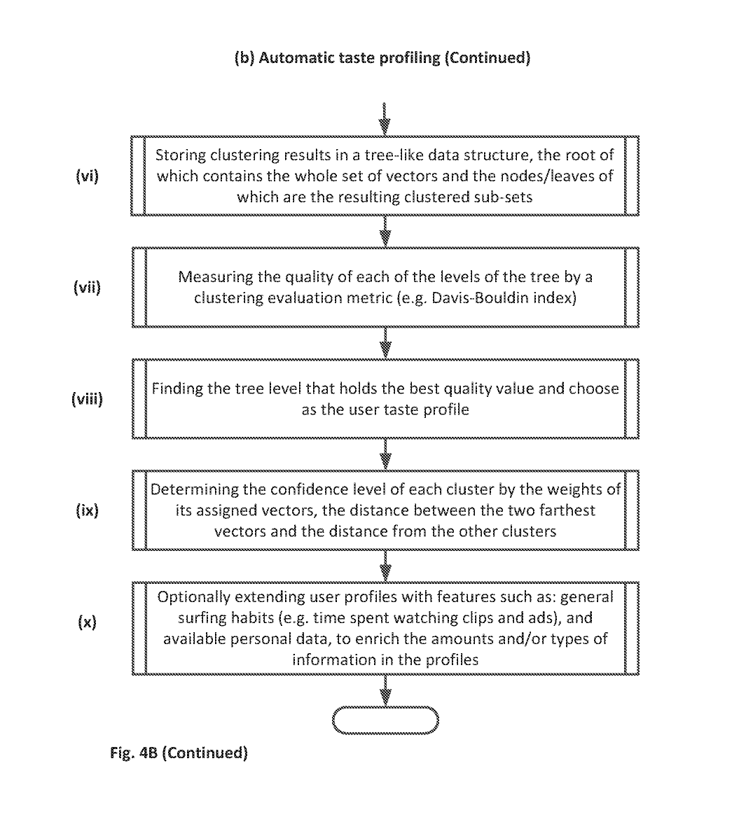

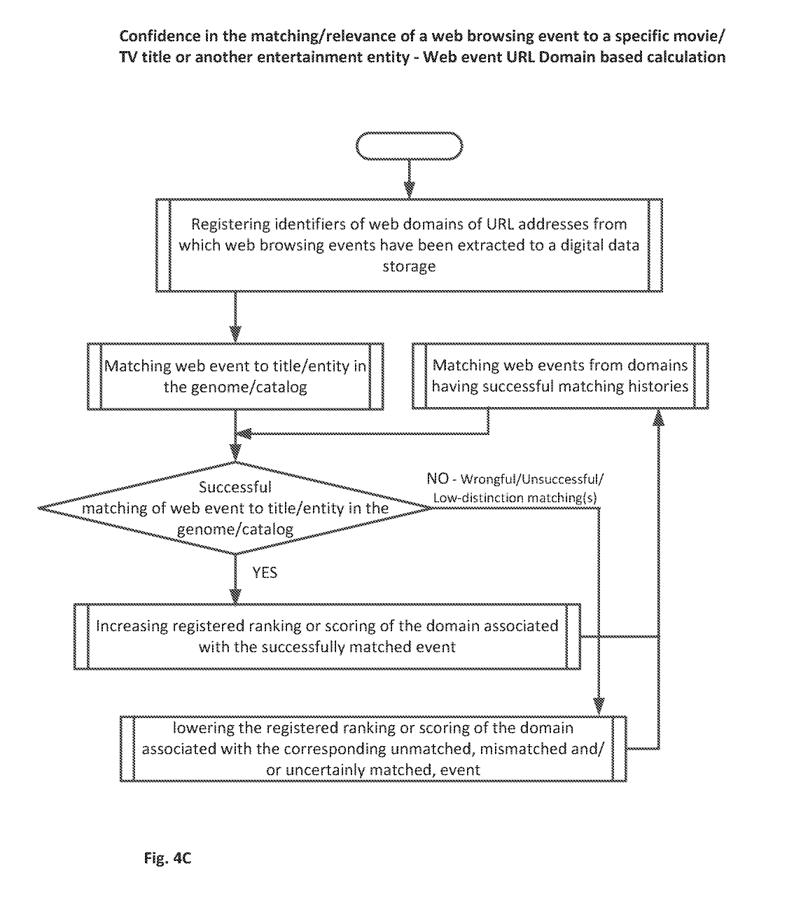

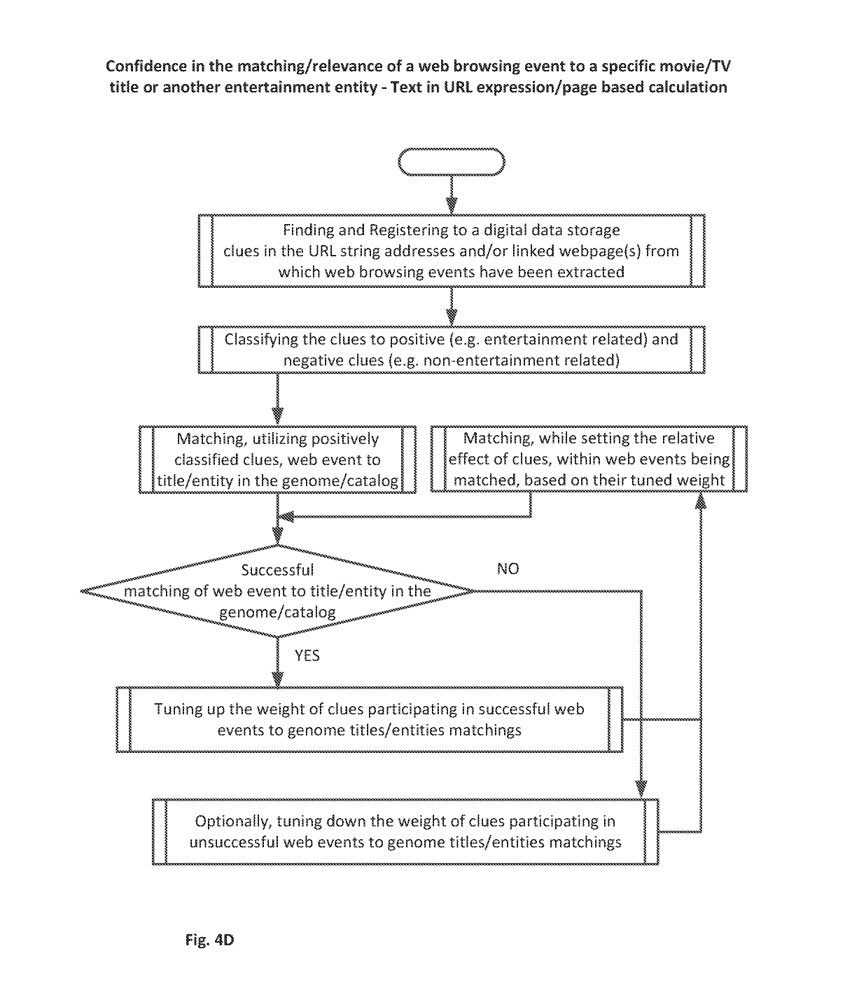

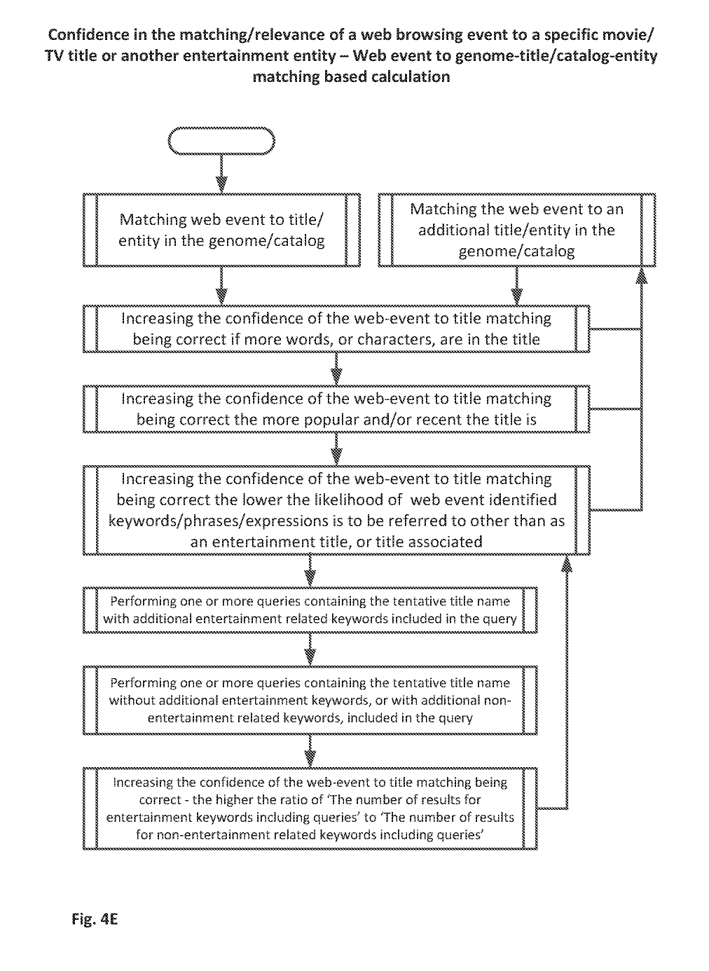

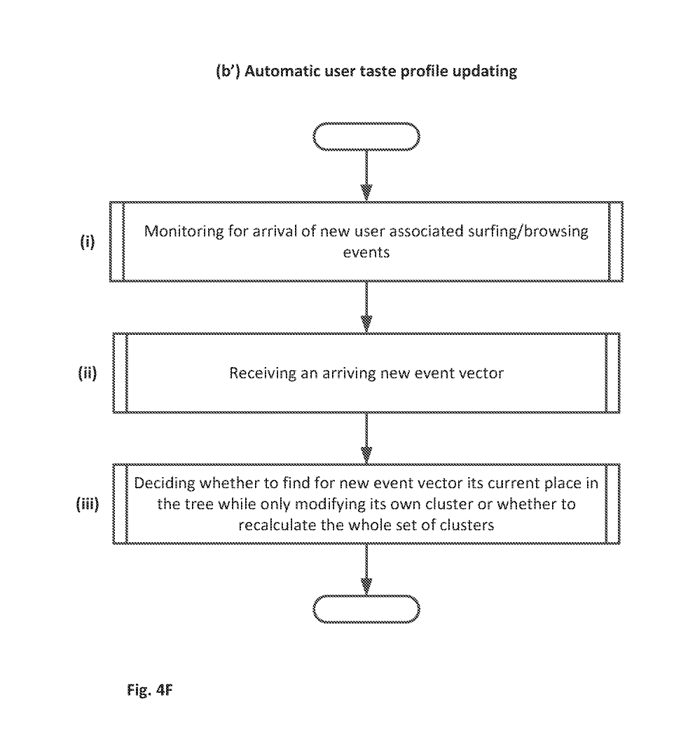

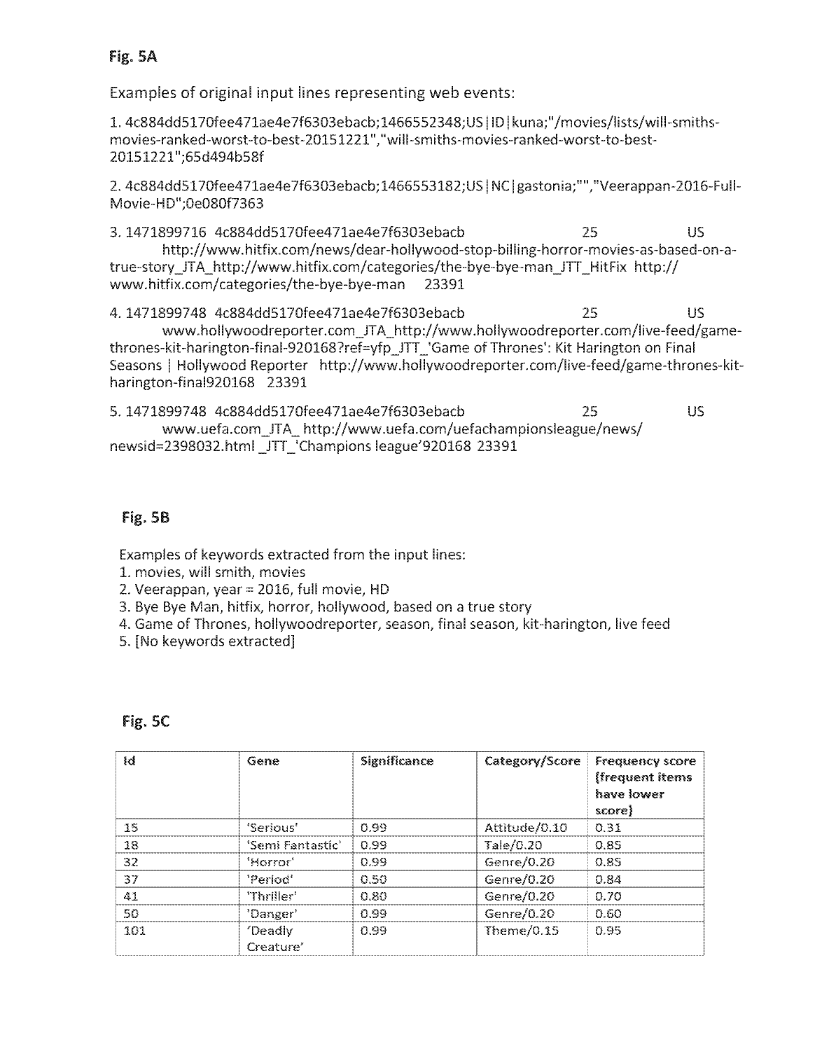

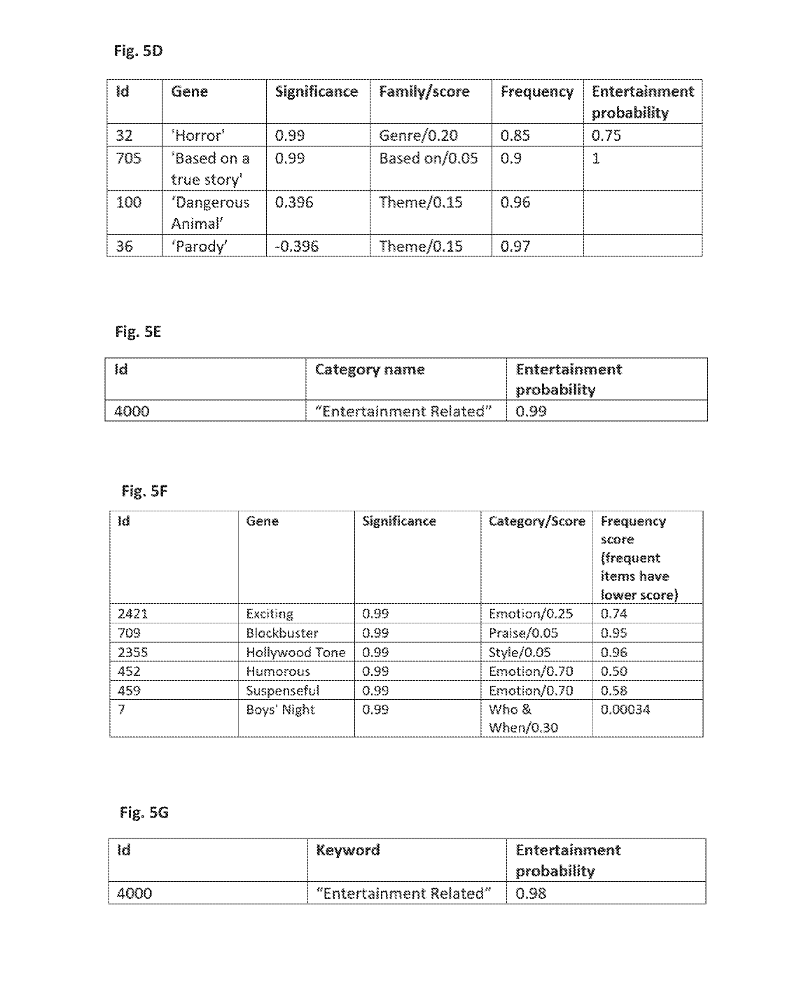

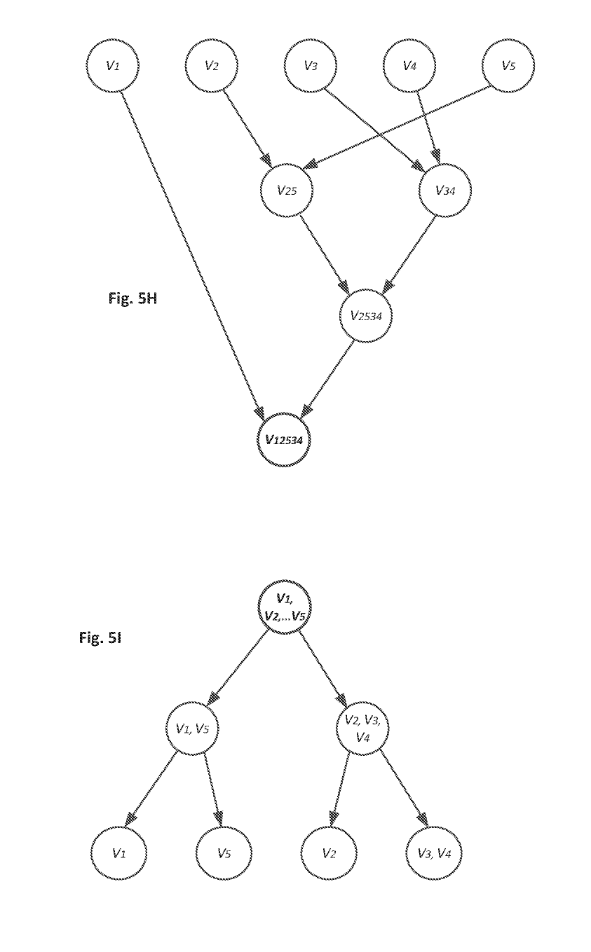

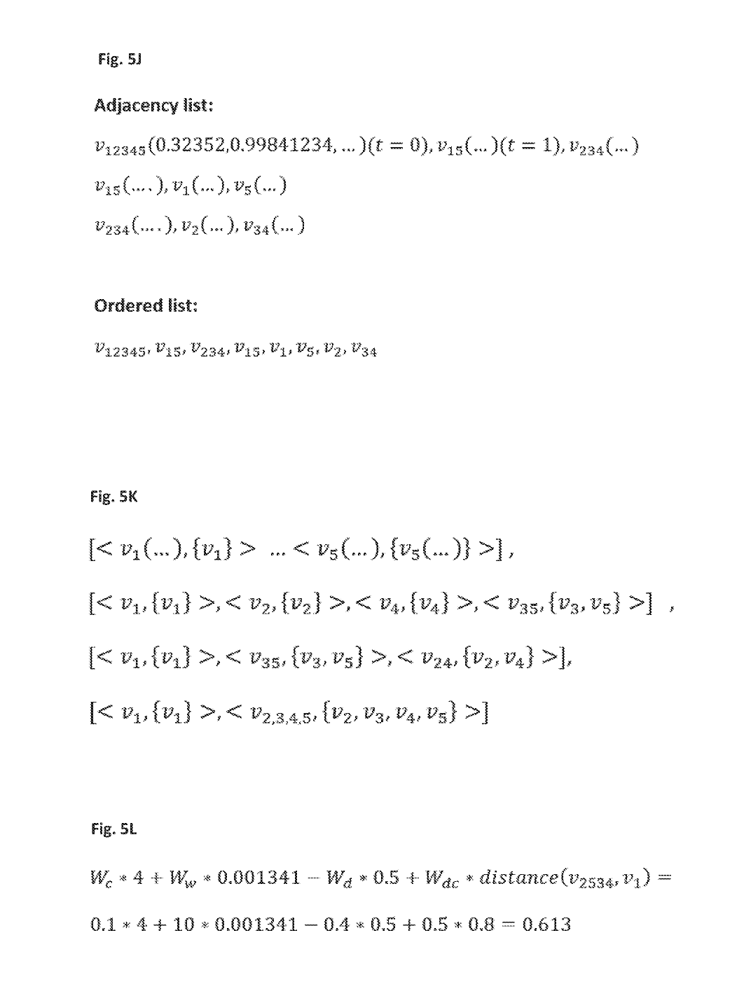

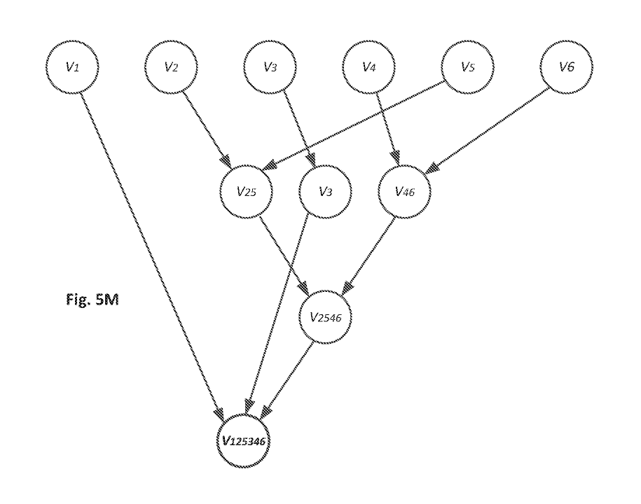

In FIG. 3A there are shown exemplary web server log lines representing actual web events;

In FIG. 3B there are shown exemplary ‘clean’ web server event lines, corresponding to those of FIG. 3A;

In FIG. 3C there is shown a set of relevant types of exemplary movie associated linguistic items, to be generated based on logged and cleaned up web event lines;

In FIG. 3D there is shown a set of exemplary movie associated linguistic items, generated based on the exemplary logged and cleaned up web event lines of FIGS. 3A and 3B, and extended using an fp-growth type algorithm;

And, in FIG. 3E there is shown a filtered set of exemplary movie associated linguistic items, generated based on the exemplary logged and cleaned up web event lines of FIGS. 3A and 3B, and extended using the fp-growth type algorithm as shown in FIG. 3D;

FIG. 4A, is a block diagram showing in further detail the main modules, components and flow, of an exemplary User Taste Profiling Server, in accordance with some embodiments of the present invention;

FIG. 4B, is a flowchart showing the steps executed as part of an exemplary process for automatic taste profiling, in accordance with some embodiments of the present invention;

FIG. 4C, is a flowchart showing the steps executed as part of an exemplary process for calculating the confidence in the matching/relevance of a web browsing event to a specific movie/TV title or another entertainment entity—based on web event URL Domain—in accordance with some embodiments of the present invention;

FIG. 4D, is a flowchart showing the steps executed as part of an exemplary process for calculating the confidence in the matching/relevance of a web browsing event to a specific movie/TV title or another entertainment entity—based on text in URL expression/page—in accordance with some embodiments of the present invention;

FIG. 4E, is a flowchart showing the steps executed as part of an exemplary process for calculating the confidence in the matching/relevance of a web browsing event to a specific movie/TV title or another entertainment entity—based on web event to genome-title/catalog-entity matching—in accordance with some embodiments of the present invention;

FIG. 4F, is a flowchart showing the steps executed as part of an exemplary process for automatic user taste profile updating, in accordance with some embodiments of the present invention; and

FIGS. 5A-5M, show exemplary data types and structures associated with the steps executed as part of exemplary processes for automatic taste profiling and automatic user taste profile updating, in accordance with some embodiments of the present invention, wherein:

In FIG. 5A there are shown original web-events representing input lines;

In FIG. 5B there are shown sets of relevant movie associated linguistic items based on each of the original input lines shown in FIG. 5A;

In FIG. 5C there is shown a table containing entries of some exemplary genes retrieved from the predefined genome for the title ‘The Bye Bye Man’;

In FIG. 5D there is shown a table including entries of genes that were found within the set of linguistic items extracted from the corresponding web event associated with the title ‘Bye Bye Man’;

In FIG. 5E there is shown a table including a single entry for the linguistic items “hitfix” and “Hollywood”;

In FIG. 5F there is shown a table including the most dominant genes (genes with the highest score values) in Will Smith played movies;

In FIG. 5G there is shown a table including an entry, or a ‘pool’/‘category’ entry, for the linguistic-item/keyword ‘movies’ that appeared in the corresponding web event of this example, twice;

In FIG. 5H there is shown an exemplary vector clustering tree structure, wherein during generation of the tree shown, the stop condition of the algorithm was satisfied before merging v₁ and v₂₅₃₄;

In FIG. 51 there is shown an exemplary vector clustering tree structure, wherein during generation of the tree shown, the cluster including v₃ and v₄ was not split;

In FIG. 5J there is shown an exemplary adjacency list and an exemplary ordered list based thereof;

In FIG. 5K there is shown an exemplary input set for a clustering quality evaluation;

In FIG. 5L there is shown an exemplary implementation of the above cluster confidence level measurement formula;

And, in FIG. 5M there is shown an exemplary new web/browsing event vector insertion process result, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system' s registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

Throughout the specification and the following discussions:

The term ‘Genome’ may refer to a pre-defined structured taxonomy of media-specific content features/characteristics, structured in content categories, and degreed by salience scores and/or confidence measures; each such feature/characteristic is referred to as a ‘Gene’ hereinafter.

The term ‘User Profile(s)’, ‘User Taste Profile(s)’, ‘Semantic User Taste Profile(s)’, or ‘Domain Specific Semantic User Taste Profile(s)’ may refer to a set of user-specific preference values, associated with characteristics of a specific domain, for example media content. A ‘User Taste Profile’ may be structured as one or more clusters of vectors of semantic features from the Genome taxonomy and/or from additional sources of domain-related (e.g. entertainment-related) features, wherein each cluster may represent one taste of the given user. A ‘User Profile(s)’ may further include ‘non-taste features’ such as: general surfing habits (e.g. time spent watching clips and ads), and available personal data, to enrich the amounts and/or types of information in the profiles.

The term ‘Distance/Similarity’, or ‘Semantic Distance Similarity’, may refer to the result of a mathematical similarity function used to determine/estimate the level of similarity between tastes, for example, semantic user taste profiles and a profile of an advertising content title.

The term ‘Content’, and/or any other more specific content-describing terms such as ‘advertising content’, ‘ad item’, ‘secondary content’ or the like, is not to limit the scope of the associated teachings or features, all and any of which may refer and apply to any form of digital content known today, or to be devised in the future.

The above described terms—‘Genome’, ‘Gene’, ‘User Profile’/‘Semantic User Taste Profile(s)’, ‘Semantic Distance Similarity’ and/or ‘Content’—are further defined, exemplified and elaborated on, in applicant's U.S. patent application Ser. No. 12/859,248, U.S. patent application Ser. No. 13/872,115 and U.S. Provisional Patent Application No. 62/333,291, which are incorporated by reference hereto, in their entirety.

The term ‘Movie’ may refer, throughout the specification, to any story or event recorded, at least visually, in a digital or an analog manner by a camera, as a sequential set of moving images. A ‘Movie’ may be shown/presented/displayed: in a theater or a hall, on television and/or over the screen of computerized device(s)—directly from the memory of the computerized device(s) and/or from other computerized device(s) (e.g. a Server) networked thereto and adapted to allow for presentation of the recorded story or event, for example, by allowing for its streaming or downloading. In the context of the present invention, the term ‘Movie’ may refer to any type of: image-set, motion picture show, animation, film, feature film, cinema production, video, clip, T.V. show chapter or episode, or the like.

The term ‘Linguistic Item(s)’ may refer, throughout the specification, to any: keyword(s), phrase(s), multi-word expression(s), text(s), string(s), and/or set(s) of characters, found within a network-event or web-event line(s).

The terms ‘Record(s)’ may refer, throughout the specification, to any title, entity, data field and/or information piece, that may be included in a Catalog or Data-store of data records relating to, or associated with, a specific domain or group of domains. Throughout the specification, the use of any specific subset of the terms: title, entity, data field and/or information piece; is not to limit the description to a specific type of data or information and may be interpreted as relating to any combination of the listed terms.

Some or all of the following embodiments, and in particular those associated with filtering and extraction of valuable data from web-browsing events and generation of user taste-profiles based thereof, are described in the context of users web-surfing/browsing Internet websites. It is hereby made clear, that at least some of the described embodiments may likewise apply to, and be utilized for, the generation of user taste profiles (and/or user profiles including user-taste components) based on the extraction of valuable data from any type, or combination of types, of user interaction with a computerized device and/or an online/networked computerized device. Such online or networked computerized devices, may for example include, but are not limited to: a computerized device running a mobile application, and/or a TV set-top-box navigation unit.

The present invention includes systems, methods, devices, circuits, and associated computer executable code for taste profiling of Internet users.

According to some embodiments of the present invention, a system for taste profiling of Internet users may comprise: (1) User Events Analysis Server for filtering and extraction of valuable data from web-browsing events; and/or (2) a User Taste Profiling Server for automatic generation and maintenance of semantic, domain specific, taste profiles for users associated with the filtered and extracted web-browsing events.

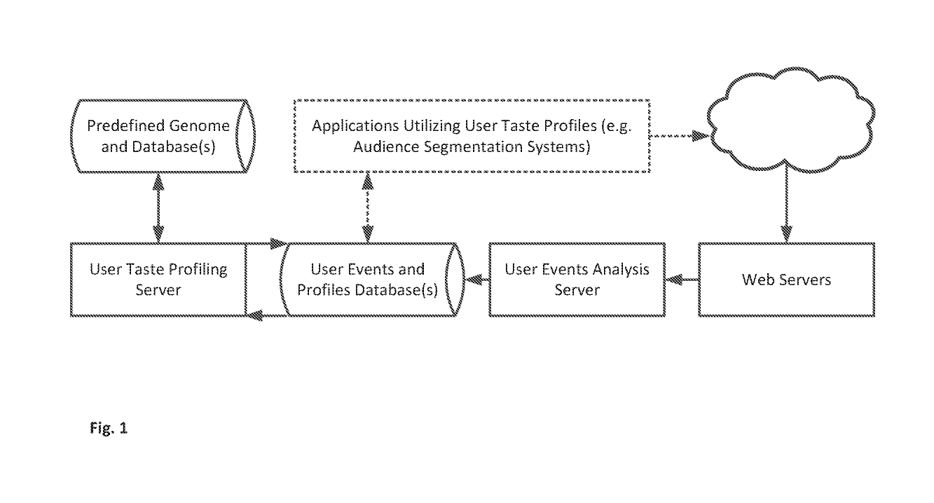

FIG. 1, is a block diagram showing the main modules, components and flow, of an exemplary system for taste profiling of internet users, in accordance with some embodiments of the present invention; shown in the figure, are: Web Servers, a User Event Analysis Server and a User Taste Profiling Server communicatively associated with a Predefined structured Genome database(s) of content (e.g. entertainment) features/characteristics.

The modules and components are shown, along with the general interrelations and processes they implement for building and/or managing user taste profiles and populating or updating the associated User Events and Profiles Database(s). Further shown in the figure, is an ‘Applications Utilizing User Taste Profiles’ block (e.g. an Audience Segmentation System) representing other systems or applications that may benefit from, or integrate data of, the Semantic User Taste Profiles generated by the system of the present invention.

The above exemplified system architecture is shown to include a User Taste Profiling Server, a User Event Analysis Server, and one or more User Events and Profiles Database(s). The shown and described example, however, is not to limit the possible architecture or structure of the invention's system. Various, single server embodiments of the invention may be implemented; alternatively, centralized, or distributed, Multi-Server architecture embodiments, wherein the system's servers, and optionally external servers (e.g. 3^{rd} party web servers, system products application servers), are communicatively associated, may be implemented. System databases may be likewise implemented as a single database and/or as multiple local and/or remote databases functionally associated with corresponding system servers or logics and/or components.

(1) Filtering and Extraction of Valuable Data from Web-Browsing Events

According to some embodiments of the present invention, web-browsing events may be logged, processed, and filtered out of irrelevant data. Specifically related features (e.g. entertainment related features) may then be extracted from each relevant event. Events may, for example, consist of a URL address and website properties.

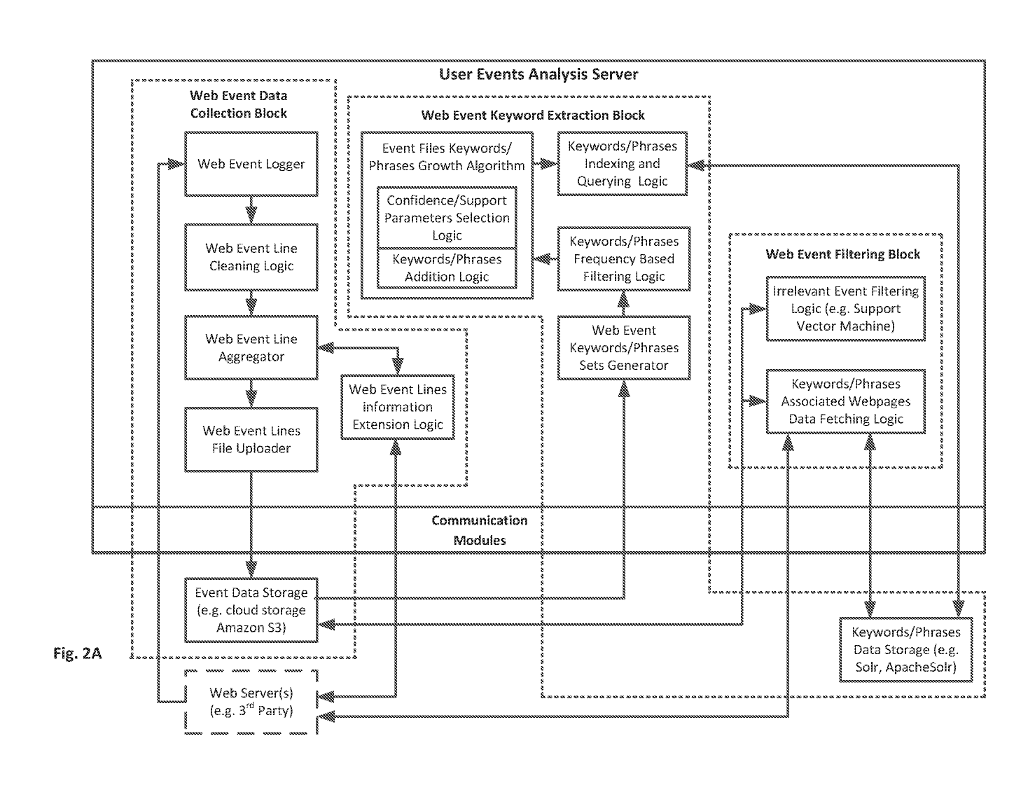

FIG. 2A, is a block diagram showing in further detail the main modules, components and flow, of an exemplary User Event Analysis Server, in accordance with some embodiments of the present invention. The shown User Event Analysis Server comprises:

### (A) a Web Event Data Collection Block Including:

(1) a Web Event Logger for logging events representing Internet/Network surfing/browsing activity of a user in a website. The event data record lines may include, but are not limited to include: user id, event timestamp(s), geographic and/or demographic details about the user, and details about the surfed website (e.g. URI, URL). Such events may be collected from third parties web server(s) and/or by inserting a so called ‘pixel’ into relevant websites that may provide user activity events associated data.

A ‘pixel’, ‘tracking pixel’ or ‘data collection pixel’, in accordance with some embodiments, may constitute of an invisible (i.e. user transparent) tag that resides on web pages which, when visited by a browsing user, generates a notice of those visits. Pixels may often work in conjunction with cookies, recording when a particular computer visits a specific page, and may, for example, be either JavaScript or image based.

The ‘pixel’ may collect peripheral information about/associated-with the visited web page itself and/or its URL, and add it to the logged web event, such information may include, but is not limited to, a ‘referral URL’ source, of the previous page from which it was referred to the current, pixel including, one.

In FIG. 3A there are shown exemplary web server log lines representing actual web events.

Returning now to FIG. 2A, there is further shown (2) a Web Event Line Cleaning Logic for parsing/separating the received web-event lines into their different data fields, removing extra or irrelevant data fields, and/or removing extra or irrelevant characters from relevant data fields or substituting some or all of the relevant data fields with respective shortened representations/formats. In FIG. 3B there are shown exemplary ‘clean’ web server event lines, corresponding to those of FIG. 3A. Shown examples of ‘clean’ web event lines include the following data fields: [user id, timestamp, country, state, city, cleaned URL].

Returning now to FIG. 2A, there are further shown: (3) a Web Event Lines information Extension Logic for retrieving additional or missing information from surfed websites associated with the logged web event lines and/or from other websites relevant thereto, and respectively integrating the additional or missing information into the ‘cleaned’ web event lines, thus complementing and/or extending them. The Lines information Extension Logic may take the form of a web crawler, such as an Internet bot which systematically browses the World Wide Web, or a subset of websites that are estimated to provide additional line information extension relevant data.

(4) a Web Event Line Aggregator for aggregating sets of two or more ‘cleaned’ web event lines into files.

(5) a Web Event Lines File Uploader for uploading the web events lines containing files and storing them to (6) a local and/or networked/remote/cloud Data Storage.

According to some embodiments, a substantially large number of raw, or partially processed, records of web events may be logged, cleaned, extended, aggregated and/or uploaded and registered to an Event Data Storage Database. For example, substantially all browsing activity events of substantially all users of a ‘taste profiling’ based application (e.g. a crowd segmentation application, a content recommendation application) may initially be logged and registered to the Event Data Storage Database as potential candidates for the generation and/or enrichment of taste profiles for the web events associated users.

### (B) a Web Event Keyword Extraction Block Including:

(1) a Web Event Keywords/Phrases Sets Generator for finding relevant linguistic items (e.g. entertainment/movie associated keywords/phrases) within each of the collected and stored web-event lines, and generating a set of relevant linguistic items based thereof, including, for example, entertainment/movie associated terms, such as: title names and aliases (AKAs), actor names, movie character names and some general entertainment related terms like “TV”, “movie”, “watch online” etc.

According to some embodiments, linguistic items such as keywords and phrases, considered relevant, may include any text, string, or set of characters, found within one or more of the collected and stored web-event lines; wherein the text/string/set matches, or is included within, a record(s) of an entertainment titles catalog(s) and/or a data-store(s)/data-source(s) including entertainment/media-related terms. Event line(s) linguistic-items such as keyword(s)/phrase(s) may be compared and matched to catalog/data-store record(s) including, for example: media content names such as titles and/or aliases of movies or TV shows, names of movie/show actors/actresses, names of movie/show characters and/or general entertainment related terms. In FIG. 3C there is shown a set of relevant types of exemplary movie associated linguistic items, to be generated based on logged and cleaned up web event lines.

Returning now to FIG. 2A, there are further shown: (2) a Keywords/Phrases Frequency Based Filtering Logic for filtering the initial set(s) of linguistic items generated. Frequent linguistic items in English which are less frequent in the relevant field (e.g. the entertainment world), and which do not appear together with other previously listed linguistic items, are filtered out. Frequency is calculated by using two corpora, one for English words in general texts (e.g. Wikipedia) and the other for words in the relevant field (e.g. movie reviews on entertainment websites).

(3) an Event Files Keywords/Phrases Growth Algorithm—an fp-growth algorithm or variant thereof—which includes: (i) a Confidence/Support Parameters Selection Logic for choosing, by rounds of experiments and possibly in combination with human expert evaluations, the confidence/support parameters for each of a set of one or more executions of the fp-algorithm; and (ii) a Keywords/Phrases Addition Logic for utilizing content matching techniques to respectively search and find, for each, of some or all of the generated linguistic items sets, websites/webpages/web-locations containing the linguistic items (and/or keywords/phrases substantially similar to those linguistic items) already found in the set; and for adding to the linguistic items already found in the set, additional linguistic items which appear on the found websites/webpages/web-locations, together with, at the proximity of, and/or in connection with, the linguistic items already found in the set.

hi FIG. 3D there is shown a set of exemplary movie associated linguistic items, generated based on the exemplary logged and cleaned up web event lines of FIGS. 3A and 3B, and extended using the fp-growth type algorithm. Among the linguistic items shown: ‘2016’, ‘news’ and ‘culture’ were added to the set by using the fp-growth type algorithm, while the others belonged to the initial set.

Returning now to FIG. 2A, there are further shown: (4) a Keywords/Phrases Indexing and Querying Logic, for indexing (e.g. hashing) linguistic items in the extended (fp-growth) set and accordingly registering them to a (5) Keywords/Phrases Data Storage. The Keywords/Phrases Data Storage shown in the figure may be a computerized component or a server, also adapted for efficiently querying the linguistic items records based on their index, as a substantially-large/growing number of new web-event lines are received by the system and analyzed.

### (C) a Web Event Filtering Block Including:

(1) a Keywords/Phrases Associated Webpages Data Fetching Logic for utilizing the extended linguistic items set to fetch further webpages and deduct further understanding in regard to logged web events. URI/URLs are searched in the web and properties of relevant web pages are fetched and associated with their corresponding previously registered web event linguistic items.

And (2) an Irrelevant Event Filtering Logic for applying a machine learning classification algorithm, for example a Support Vector Machine (SVM), to the resulting set of the tentatively relevant logged web-events, and to filter out irrelevant events.

For example, for the set of exemplary movie associated linguistic items of FIG. 3D, in certain fetched pages about ‘Nintendo’ it was indicated that it is mostly related to as a computer game console and the movie by that name has only a secondary priority in the interpretation.

According to some embodiments, certain web events, initially estimated to be movie, or entertainment, related, may be accordingly removed (e.g. deleted, black-flagged, moved to another memory location/address) from the Event Data Storage database, thus maintaining the number of web event records in the database at a useful minimum and improving the efficiency of following: sorting, searching, querying and/or updating of the database records.

Web events including linguistic items associated with record(s) of the entertainment titles catalog(s) and/or the entertainment/media-related terms data-store(s)/data-source(s), and thus considered relevant to the taste profile of the user which is the source for the web-event(s), may nevertheless, be filtered-out and removed from consideration. Relevant linguistic items may be removed from consideration and excluded from taste profile calculation, for example, when their title or their associated text, although found in the catalog/data-store, is a commonly used word/term with little to no effect on the probability of the web-event actually being entertainment related—The word ‘Speed’ for example, may represent in the catalog a movie by that name, the probability of the word ‘Speed’ when found in a random web-event to actually relate to the movie by that name, is however slim, as it is a common word/term in various non-entertainment related fields (e.g. motor vehicles, sports, aerodynamics).

The training set for the classification algorithm may be collected by searching surfing/browsing events for some well-known specifically related (e.g. entertainment related) phrases (e.g. referring to movies). The text classification algorithm may filter out following real-user web events and/or linguistic items thereof, if they fall on a ‘non-entertainment-related’ side of an entertainment-related/non-entertainment-related classifying hyperplane generated based on the training set, or if their margin, or ‘distance’, from the generated classifying hyperplane is smaller than a predetermined threshold value.

According to some embodiments, as part of considering the filtering-out of a given browsing event, additional associated browsing events may be taken into account by using an analysis of links from and to the web page associated with the given event. Additional associated browsing events may include browsing events web pages or places that are mostly linked from, or that mostly link to, the given event or website thereof.

In FIG. 3E there is shown a filtered set of exemplary movie associated linguistic items, generated based on the exemplary logged and cleaned up web event lines of FIGS. 3A and 3B, and extended using the fp-growth type algorithm as shown in FIG. 3D. In the figure: line 1 has been removed by the Irrelevant Event Filtering Logic (e.g. SVM), as results from the Keywords/Phrases Associated Webpages Data Fetching Logic, indicated that the linguistic-item/keyword ‘Nintendo’ mostly appears within other webpages (from which data has been fetched) in association with, or relating to, a computer game console rather than a movie title; line 4 in the figure has been removed by the Irrelevant Event Filtering Logic (e.g. SVM) as an irrelevant event generally related to, or including linguistic items relating to, culture.

FIG. 2B, is a flowchart showing the steps executed as part of an exemplary process for filtering and extraction of valuable data from browsing events, in accordance with some embodiments of the present invention.

According to some embodiments, a User Events Analysis Logic may execute the following steps for filtering and extraction of valuable data from web-browsing events:

(i) Logging surfing/browsing events of users from a web-server(s) (e.g. 3rd party server), and/or receiving logged surfing/browsing events data from a third party.

(ii) Filtering out irrelevant data and retaining only the relevant entertainment events by applying a text classification algorithm (e.g. SVM). The training set for the classification algorithm is collected by searching and collecting surfing/browsing events for some well-known specifically related (e.g. entertainment related) phrases (e.g. referring to movies). According to some embodiments, searching and collecting surfing/browsing events for some well-known specifically unrelated (e.g. non-entertainment related) phrases may be utilized for construction of a negative training set. Other events, referring to a given web event including the specifically related phrases, or being referred to from it, may be taken into account by using an analysis of links from and to the web page associated with the given web event.

(iii) Utilizing machine learning techniques for identifying informative structures which expose specifically related (e.g. entertainment related) features and help ignore irrelevant features (e.g. using a scalable implementation of the fp-growth [Frequent-Pattern Growth] algorithm by J. Han et. al.).

And/or (iv) Calculating frequencies of the informative expressions and phrases, using language processing methods for filtering the less informative among them and integrating the information into database indices (e.g. as demonstrated in FIG. 3).

### (2) Automatic Taste Profiling

According to some embodiments of the present invention, the domain specific, semantic taste profile of a given user may be calculated incrementally upon arrival of new events for that user. For each user, each relevant event may be represented as a vector of features which participate in the taste profile calculation.

FIG. 4A, is a block diagram showing in further detail the main modules, components and flow, of an exemplary User Taste Profiling Server, in accordance with some embodiments of the present invention. The shown User Taste Profiling Server comprises:

### (A) a Vector Generation Block Including:

(1) a Keyword Extraction and Event Matching Logic for finding relevant linguistic items (e.g. movie associated keywords/phrases) within each of the collected web-event lines stored to the Event Data Storage, and generating a set of relevant linguistic items based thereof, including, for example, movie associated terms, such as: title names and aliases (AKAs), actor names, movie character names and some general entertainment related terms like “TV”, “movie”, “watch online” etc. In FIG. 5B there are shown sets of relevant movie associated linguistic items based on each of the original input lines shown in FIG. 5A.

The Keyword Extraction and Event Matching Logic may be utilized for matching a given web browsing event, which is the source of a corresponding generated set of relevant linguistic items such as keywords and phrases, to a specific movie/TV title, or another entertainment entity, found in the Predefined Genome Databases of media/entertainment-specific content features/characteristics.

According to some embodiments, the confidence in the matching or relevance of a given web browsing event to a specific movie/TV title or another entertainment entity may be calculated at least partially based on a combination of the following measures of presumed relevance: (a) the domain of the URL address of the web event, (b) text in the URL expression and optionally in certain parts of the URL browsed page and/or (c) the potentially matching title or entity in the genome or catalog, respectively.

(a) The Domain Relevance may be determined by the degree of ‘usefulness’ of the given web browsing event domain in previous applications of the system. According to some embodiments, identifiers of web domains of URL addresses from which web browsing events have been extracted may be registered to a digital data storage.

With each successful, or substantially highly distinct/significant, matching of a web event to a title or entity in the genome, the catalog, and/or the entertainment-related terms data store/source, respectively , a registered ranking or scoring of the domain associated with the successfully matched event, may be increased. Wrongful matching(s), inability to find a match and/or matching(s) having substantially low distinction/significance, may lower the registered ranking or scoring of the domain associated with the corresponding unmatched, mismatched and/or uncertainly matched, event.

According to some embodiments, ‘black’ and ‘white’ lists of domains, having respectively unsuccessful and successful web event(s) matching rankings/records/histories, may be generated. The ‘black’ and ‘white’ lists of domains may be utilized for following matchings to be solely, or chiefly, based on domains having successful matching histories.

(b) Textual page relevance may be determined by positive and negative clues in the URL string addresses from which web browsing events have been extracted and/or from text within the URL linked webpage(s) themselves or certain sections thereof.

According to some embodiments, positive clues may include terms that are likely to indicate movies or TV shows (e.g. movie, film, cinema, TV, episode, season), whereas negative clues may include terms that are likely to indicate generally-irrelevant but popular content areas such as, for example: business, politics, computers, music, cooking, sport and porn.

According to some embodiments, clues may carry weights representing their ‘proved’, or estimated, prediction power. Based on the history of successful web events to genome titles/entities matchings, the weight(s) of specific clue(s) participating in successful matchings may be tuned up to a higher weight, thus increasing their relative effect as part of following matchings' calculations and possibly increasing the probability of these, or similar, clues to be considered as part of future matchings' calculations.

According to some embodiments, an exemplary URL/page relevance formula may be based on the following structure: (i) Start with a clue rank of 0.5 (Rank=0.5) and a rank delta of 0.2 (Delta=0.2); (ii) Increase the rank for positive clues found in the URL string (or in associated webpage) as follows: for every positive clue, add the multiplication of Delta and the weight of the clue (Delta*ClueWeight) to the clue's Rank and update the value of Delta (Delta=0.5*Delta); (iii) Decrease the rank for negative clues found in the URL string (or in associated webpage) as follows: for every negative clue, subtract the multiplication of Delta and the weight of the clue (Delta*ClueWeight) from the clue's Rank and update (Delta=0.5*Delta).

The values selected for the parameters in the above relevance calculation are exemplary. The initial Rank value, the initial Delta value and/or the coefficient (0.5 in the above example) used to update (e.g. decrease) the value of Delta following to an addition or subtraction to the value of Rank, may receive different values depending on the application of the relevance formula. The values selected for the parameters and coefficient may at least partially depend on the number of clues found in the URL or in the associated webpage. For example, a lower value may be selected for the update coefficient for a URL that ‘supplied’ a larger number of clues and vice versa. According to some embodiments, the value of the update coefficient may be dynamically decreased as the number of clues found in the URL/page increases. According to some embodiments, various coefficient values may be selected and/or tuned depending on the level of URL/page relevance Rank volatility, or Rank distribution, aspired.

(c) Title matching confidence may be calculated/determined at least partially based on a combination of the following measures: (i) the length of the matched title name in the predefined genome or the catalog, wherein the more words, or characters, are in a given title, the higher the confidence of the web-event to title matching being correct; (ii) the title popularity and age, wherein the more popular and/or recent a given title is, the more likely it is to be looked up by users and appear in user associated web events and thus increase the confidence of the web-event to title matching being correct; and/or (iii) statistical term frequencies, wherein the likelihood of an identified web event linguistic-item/keyword/phrase/expression to be referred to other than as an entertainment title is determined.

According to some embodiments, the likelihood of a given web event linguistic-item/keyword/phrase/expression referring, or not referring, to an entertainment title in the predefined genome or the catalog may be calculated by comparing result sets from a search engine for: (i) one or more queries containing the tentative title name with additional entertainment related linguistic items included in the query, and (ii) one or more queries containing the tentative title name without additional entertainment linguistic items, or with additional non-entertainment related linguistic items, included in the query.

The calculation of the likelihood/probability of: a title name, an actor/actress name, a character name or alias and/or a content feature (gene), to appear in entertainment contexts are further described and specified hereinafter, at least in parts: (a), (b) and (c) of section (2) a Data Preparation Logic.

According to some embodiments, each of the above described measures of presumed relevance may be regarded as a separate layer, having a threshold value applied to filter out the most unlikely browsing events. An overall relevance rank (confidence) may be calculated, as a linear combination of the three ranks assigned at the three independent layers, for web events that pass all three filters, or 2 out of 3 filters in accordance with some embodiments. The relevance ranks calculated for web events may be registered to respective web events' records in a local or a remote (e.g. cloud) data storage.

According to some embodiments, as part of calculating an overall relevance rank, a relative coefficient (weight) may be allocated for each of the relevance measures' layers. The coefficients (weights) of each of the layers may be tuned automatically or manually to reflect their relative predicting power in comparison to the other layers.

According to some embodiments, records of: web events estimated to be non-entertainment related, web events unmatched to corresponding titles/entities in the predefined genome and/or web event linguistic items sets unmatched to corresponding titles/entities in the predefined genome, may be removed (e.g. deleted, black-flagged, moved to another memory location/address) from the Event Data Storage database, thus maintaining the number of web event records in the database at a useful minimum and improving the efficiency of following: sorting, searching, querying and/or updating of the database records.

(2) a Data Preparation Logic for retrieving—from: the predefined genome database of media/entertainment-specific content features/characteristics, the movie/TV titles catalog and/or the entertainment-related terms data store/source—information (e.g. features/characteristics) relevant to specific movie/TV title(s) successfully matched to corresponding web browsing event(s) and/or to relevant linguistic items thereof. The information may be retrieved, organized and/or arranged at least partially based on the type and/or characteristics of each of the linguistic items extracted, wherein specific types and/or characteristics of linguistic items may trigger one or more of the following actions:

(a) If the linguistic item (e.g. keyword/phrase) is a movie/TV title, relevant genes from the genome, and associated details, are fetched and used as parameters for a similarity function as described hereinbefore. Relevant genes may include, but are not limited to:
(i) The salience (score of significance) of each gene in the given title.
(ii) The relative importance (relevance for similarity) of the content category to which each gene belongs.
(iii) The frequency of each gene in the given content catalog, wherein more common is generally less significant.
(iv) The semantic relations of the genes to the other genes in the genome.
(v) The probability of the title name to appear in entertainment contexts, wherein the probability is measured by querying a search engine for the title name and calculating the ratio between the number of results that contain entertainment related linguistic items and the total number of results. A higher—‘entertainment-containing-results-number’ to ‘all-results-number’ ratio—may indicate a higher likelihood/probability of an identified web event, or web event linguistic item such as a keyword/phrase/expression, to refer to the entertainment title.

(b) If the linguistic item (e.g. keyword/phrase) is a gene from the pre-defined genome, it is fetched along with some associated details such as, but not limited to:
(i) The probability of the gene to appear in entertainment contexts (calculated similarly as in the previous section).
(ii) The relative importance (relevance for similarity) of the content category to which each gene belongs.
(iii) Its frequency in the given content catalog, wherein more common is generally less significant.

(c) If the linguistic item (e.g. keyword/phrase) is a movie actor/actress or character name:
(i) Its dominant genes are fetched. For each actor or character, a set of representing movies, wherein the actor/character takes a significant role, is selected. Selection is done by an algorithm that searches the web occurrences of the actor/character together with movies/titles, and chooses the most dominant among them. For example, the movies/titles, belonging to the actor/character-movies/titles pairs yielding a higher number of search results (i.e. higher number of mutual web appearances), may be selected as the dominant movies/titles associated with that specific actor/character. After choosing the dominant movies/titles, their most dominant genes are selected as the dominant genes of the actor/character.
(ii) The probability of the actor/character name to appear in the actor/character context is measured.
(iii) Additional details, similar to those fetched for the title, are fetched.

(d) Elsewise (i.e. none of the above apply):
(i) If the linguistic item (e.g. keyword/phrase) is important enough, it is fetched with its score—its probability to appear in entertainment contexts, as measured in (a), (b) and (c) above.
(ii) Otherwise, a better representing and more general linguistic-item(s)/keyword(s) are fetched—wherein the most general linguistic-item/keyword is “Entertainment related”.

Retrieved, organized and/or arranged, predefined genome information that is relevant to the extracted web events linguistic items may be stored, temporarily—as part of vector generation process, or permanently, to a Vector Generation Database shown in FIG. 4A.

(3) an Event Vector Generator for building vectors for specific user browsing events. Retrieved, organized and arranged information—relating to the linguistic items of a specific, movie/TV title matching, web event—may be utilized to build/generate/populate a vector of that specific web event representing the semantic tastes it is associated with. Building the event vector(s) may include a combination of the following described and exemplified actions:

(a) Representing each predefined genome gene of the movie/TV title, or other entertainment entity, matched to the web browsing event for which a vector is being built, by a dedicated entry in the generated vector(s).

(b) Representing important linguistic items (e.g. manually selecting) extracted from the web browsing event for which a vector is being built and also found in the predefined genome, by dedicated entries in the generated vector(s).

(c) Representing general entertainment related linguistic-item/keyword categories found in the predefined genome, for linguistic items extracted from the web browsing event for which a vector is being built, by entries in the generated vector(s). Linguistic-item/Keyword categories may, for example, include: “Entertainment related”, “TV series”, and “interview about a movie”; the category “TV series” may, for example, include the linguistic items or keywords: “series”, “season”, “chapter” and more. The general entertainment related linguistic-item/keyword categories are an extension to the genome categories described hereinbefore (for example: sections (2)(a)(ii) and (2)(b)(ii) above).

(d) Modifying the entry values of genes/linguistic-items/keywords/keywords of category—with each of their occurrences, and in accordance with their fetched score values and details: (i) If a gene/ linguistic-item/keyword/keyword of category appears few times in an event, value(s) of corresponding vector entry(ies) may be increased accordingly.
(ii) If the gene's/keyword's/linguistic-item's category contains some other genes, the other genes may be represented by entries in the generated vector(s) and their value(s) may be increased, wherein the value increase may be substantially slight in comparison to the increase in value of vector entries for genes directly/explicitly found and extracted from the web browsing event for which a vector is being built. For example, the gene ‘Dangerous Animal’ (found in the event) is related to (e.g. in the same category as) the gene ‘Deadly Creature’ with a relation value of 0.4, therefore, it may be added as an entry in the generated vector with a comparably low salience/significance of 0.4*0.99=0.396.
(iii) Some of the genes may have a negative relation with others, for example, toddlers and profanity. Accordingly, appearance of a given gene may trigger a decrease in the value(s) of vector entries of gene(s) having negative relations to it, wherein the given gene and the genes having negative relations to it are found within the same web event. The triggered decrease in entry values may, optionally, lead to negative values for some gene entries, wherein in certain cases (e.g. a very strong negative relation) these negative values may be extreme. For example, the gene ‘Serious’ (found in the event) is negatively related to the gene ‘Parody’, therefore, the gene ‘Parody’ may be added as an entry in the generated vector with a negative salience/significance of −0.4*0.99=−0.396.

(e) A first set of web event linguistic items, as shown in example 3 of FIG. 5B, includes: The Bye Bye Man, hitfix, horror, Hollywood and “based on a true story”.
(i) According to some embodiments, upon release of new entertainment related titles, the opening and registering of new corresponding database records not in the genome may be triggered. Genes, gene categories, confidence scores, frequency scores and/or other parameters associated with a new entertainment title may be extracted from title associated texts/information published as part of the release of the new title and used to populate and later update the corresponding genome titles' records. Title associated texts/information/articles may be automatically tagged, auto tagged texts/information/articles and their auto tags may optionally be human filtered, tuned and/or curated, prior to registration to genome database records. The automatic tagging process and/or the human tuning thereof may be intermittently repeated as new information associated with an existing genome title. The tagging function and operation, including parts and components thereof, is further described and exemplified in U.S. patent application Ser. No. 12/859,248 and U.S. patent application Ser. No. 13/872,115, which applications are incorporated by reference in their entirety hereto.

In FIG. 5C there is shown, in accordance with some embodiments, a table containing entries of some exemplary genes retrieved from the predefined genome for the title ‘The Bye Bye Man’. As 97% of a search engine's search results for “Bye Bye Man” included linguistic items such as ‘movie’, ‘trailer’ and/or other entertainment related linguistic items, its entertainment probability was selected/calculated to be substantially high and set to 0.97 in this example.

The semantic genes for the title ‘Bye Bye Man’, as shown in the figure, are retrieved along with values representing their significance in the title's movie and the score of the category of each of the title's genes (e.g. category: Genre; genes: Horror, Drama, Action, and Period). According to some embodiments, gene categories which are more indicative of, or provide higher convergence to, a smaller number of titles out of a similar catalog of titles, may receive a higher category score. Gene categories with higher scores may comparatively have stronger title filtering effect than gene categories with low scores. High scored categories may have shown, in previous executions, to filter out more titles unwanted by a given user, making a larger semantic leap towards his preferred, remaining, non-filtered out titles and thus his ‘taste’.

Further shown on FIG. 5C is a Frequency Score column including a frequency score for each of the genes retrieved from the predefined genome for the title, wherein frequent items, or genes, have lower score. According to some embodiments, less frequent genes may be more indicative of specific genome titles and/or of specific smaller sub-group thereof, and may thus provide more knowledge, or more focused knowledge, in regard to a given user's preferences and taste. For example, in the figure, the gene ‘Serious’ in the category ‘Attitude’ was found to be highly frequent (e.g. in comparison to other genes) as many titles in the genome/catalog include this gene (e.g. almost every movie title which is not ‘unserious’ or ‘light’) and was thus given a relatively low frequency score; the gene ‘Horror’ on the other hand, was found to have low appearance frequency (e.g. in comparison to other genes) as few titles in the genome/catalog include this gene (e.g. mostly, only a movie title which is neither: a drama, a comedy nor a documentary) and was thus given a relatively high frequency score.
(ii) In FIG. 5D there is shown, in accordance with some embodiments, a table including entries of genes that were found within the set of linguistic items extracted from the corresponding web event associated with the title ‘Bye Bye Man’. The gene “Horror” appears both, within the web event linguistic items and in the predefined genome under the title Bye Bye Man' and therefore belongs in both FIG. 5C (Genome retrieved gene table) and FIG. 5D (Web event extracted gene table). The term “based on a true story” was found within the linguistic items extracted from the corresponding web event, but not in title genome under the title ‘Bye Bye Man’ and therefore belongs only in FIG. 5D but not in FIG. 5C table.

According to some embodiments, the absence of “based on a true story” from the title genome for the title ‘Bye Bye Man’ may indicate that a content tagging algorithm and/or human content experts/curators/filterers determined/estimated that the movie is not actually “based on a true story”, and therefore—the weight of the corresponding gene in the generated content/event vector may be substantially low.

According to some embodiments, the entertainment probability may be calculated for each of the genes found within the web event linguistic items. Each of the genes found within a given web event' s linguistic items may be separately searched by (i.e. be the search query for) a search engine. For a given searched gene, the ratio, between the number of yielded search results that are entertainment related and the number of yielded search results that are not entertainment related (Or, alternatively, the total number of all search query results—both entertainment related and non-related—performed) may represent, or may be the basis for the calculation of, the entertainment probability of the searched for gene.

hi FIG. 5D the are shown, the genes “horror” and “based on a true story” found within the linguistic items extracted from a web event associated with the movie ‘Bye Bye Man’. The entertainment probabilities for the genes in the figure, were selected/calculated as described hereinbefore.
(iii) According to some embodiments, an ‘Entertainment Related’ gene category, or pool, may include entertainment related linguistic items, extracted from a web event, which are not associated with any specific genome title or with any specific set of genome titles. In FIG. 5E there is shown, in accordance with some embodiments, a table including a single entry for the linguistic items “hitfix” and “Hollywood” that were extracted from the web event associated with the title ‘Bye Bye Man’, wherein the linguistic items now collectively belong to the group “Entertainment related”.

According to some embodiments, a ‘pool’ or a ‘general’ category (e.g. “Entertainment related”) may replace a set of linguistic items determined not to be individually important enough for having their own dedicated linguistic-item/keyword entries in the vectors. The entertainment probability of the multiple linguistic items representing pool/category may be, or be based on, the maximal entertainment probability value found between the entertainment probabilities of items in the set of linguistic items.

In FIG. 5E the category name “Entertainment related” may replace the linguistic items titfix' and ‘Hollywood’ which were determined not to be important enough for having a dedicated linguistic-item/keyword entry in the vectors. The entertainment probability of the new multiple linguistic items representing pool/category may be, or be based on, the maximal entertainment probability value found between the entertainment probabilities of the two separate genes included in the pool/category. The entertainment probability of each of the separate items in the pool/category may be calculated as described hereinbefore (e.g. for the entertainment probability of the linguistic-item/keyword “Horror” in 5D).
(iv) The gene ‘Serious’ is very frequent in the content catalog and therefore has a small frequency score (0.31). The rest of the gene entries have much higher frequency values (0.6−0.9). Entries 15, 18, 32, 37, 41, 50, 100, 101, 705 and 4000 have positive vector entry values while entry 36 has a negative value. All representing a combination of the above scores. The resulting vector is:
(0, 0, 0, . . . ,0.99*0.10*0.31, 0, 0, 0.99*0.20*0.85, 1.1*0.99*0.20*0.85, . . . , −0.396*0.15*0.97, 0.50*0.20*0.84, . . . ,0.1*0.99*0.05*0.9, . . . , 0.99).
   (a) The formula 0.99*0.10*0.31 represents, in the example, the weight of the gene ‘Serious’ (Lower due to its group and high frequency), the formula 0.99*0.20*0.85 represents ‘Semi Fantastic’ (low frequency), and the formula 1.1*0.99*0.20*0.85, ‘Horror’ (multiplied by 1.1 due to its multiple occurrences). The formula 0.1*0.99*0.05*0.9 represents the gene “based on a true story” and has a relatively low score because it doesn't appear in the title genome. The value 0.99 represents ‘Entertainment Related’.
   (b) All values that were added due to “Bye Bye Man” genome are multiplied by the entertainment probability of the title, for taking that probability into account.
   (c) Similarly, values that were added due to genes or linguistic items are multiplied by a square root of their entertainment probability (In many cases they have a relevant meaning even if they are not entertainment related).
      The Resulting vector is: (0, 0, 0, . . . ,0.99*0.10*0.31*0.97, 0, 0, 0.99*0.20*0.85*0.97, 0.1*0.99*0.05*0.9*√1, . . . , 0.99);

(f) A second set of fetched linguistic items, as shown in example 1 of FIG. 5B, includes: “movies”, “will smith”, “movies”.
(i) Will Smith was playing in many movies. Among them are “man in black” and “I am Legend”.
(ii) In FIG. 5F there is shown, in accordance with some embodiments, a table including the most dominant genes (genes with the highest score values) in Will Smith played movies. The probability of “Will Smith” to relate to the actor by that name is 1.0 or close to 1.0.
(iii) In FIG. 5G there is shown, in accordance with some embodiments, a table including an entry, or a ‘pool’/‘category’ entry, for the linguistic-item/keyword ‘movies’ that appeared in the corresponding web event of this example, twice.
(iv) The Vector for the event including the second set of fetched linguistic items, may be created substantially similarly as described above for the first set.

Generated event vectors information may be stored to the Vector Generation Database shown in FIG. 4A.

### (B) a Clustering Block Including:

(1) A Clustering Logic for utilizing one or more hierarchical clustering algorithms to generate a structured tree output of centroid vectors, based on the resulting event vectors described hereinbefore.

(a) A first clustering technique/algorithm, in accordance with some embodiments, may include:
(i) Receiving as input a set of event vectors: V={v₁, . . . vₙ}.
(ii) In each step/iteration, merging a pair of the most shortly distanced (closest) vectors from within the received input vectors, into a single vector, wherein distance between vectors is measured as their squared Euclidean distance. The merged vector may consist of a weighted average of its source vectors, and may be stored along with its creation time (e.g. timestamp, running index)
(iii) The execution of the algorithm may be halted once the distance between the two closest vectors is equal to, or greater than, a constant value or a predetermined threshold value (e.g. 0.54). When the algorithm halt condition is fulfilled and its execution is terminated, the last tree node level vectors may be linked to a dummy tree root vector.
(iv) In FIG. 5H there is shown an exemplary vector clustering tree structure, in accordance with some embodiments of the present invention, during generation of the tree shown, the stop condition of the algorithm was satisfied before merging v₁ and v₂₅₃₄ , since the distance between them is greater than the exemplary threshold (0.54). The bottom ‘bald’ vector is the dummy tree root vector described hereinbefore.

(b) A second clustering technique/algorithm, in accordance with some embodiments, may be applied instead of , or in parallel, to the first clustering technique/algorithm and may include:
(i) Receiving as input a set of event vectors: V={v₁, . . . vₙ}.
(ii) Starting with all vectors in the input set in the same single cluster, in each step/iteration, applying a K-means algorithm with k=2, for splitting the cluster into two different clusters. This algorithm, as in the case of the first clustering technique/algorithm, stores for each vector a creation time (e.g. temporal stamp, index).
(iii) The execution of the algorithm may be halted once the diameter (i.e. distance between vectors in a given cluster) of all vectors clusters, is equal to, or smaller than, a constant value or a predetermined threshold value (e.g. 0.6).
(iv) In FIG. 5I there is shown an exemplary vector clustering tree structure, in accordance with some embodiments of the present invention, wherein during generation of the tree shown, the cluster including v₃ and v₄ was not split since its diameter (i.e. the distance between v₃ and v₄) is not greater than the constant value, or the predetermined threshold value (e.g. 0.6).

(2) A Clustering Results Storage Logic for processing and storing the results of the structured tree outputs generated using the clustering techniques/algorithms described hereinbefore. The clustering results, representing concise user taste profiles, may be stored to a Taste Profile Database as shown in FIG. 4A.

(a) Processing and storing the clustering techniques/algorithms results, in accordance with some embodiments, may include:
(i) Converting the resulting structured tree to an adjacency list representation.
(ii) Storing the creation time (e.g. timestamp, index) vertex/node in the tree.
(iii) Generating a list of the vectors, ordered according to their creation time/order.
(iv) Storing the results to a database (e.g. cloud storage) for later reference.
(v) In FIG. 5J there is shown an exemplary adjacency list and an exemplary ordered list based thereof, in accordance with some embodiments of the present invention, wherein the adjacency list is based on exemplified results of the above, second, clustering technique/algorithm.

(3) A Clustering Results Quality and Confidence Measuring Logic for traversing the structured tree in accordance with (along) the order of the ordered list, while replacing node(s), step by step, with corresponding merged-node/split-nodes, measuring the quality of each of the steps and selecting a tree level for clustering based thereof, and measuring/calculating a confidence level for each cluster in the selected clustering. According to some embodiments, the node/leaf replacement technique may require storing the tree itself and not only the ordered times list.

(a) A first clustering technique/algorithm (described hereinbefore) structured tree traversing process, in accordance with some embodiments, may include:
(i) Starting with all tree leaves.
(ii) In each step, replacing each couple of two successor nodes/leaves in the tree with the next node in the list, while measuring/calculating the quality of the step.

(b) A second clustering technique/algorithm (described hereinbefore) structured tree traversing process, in accordance with some embodiments, may include:
(i) Starting with the tree root.
(ii) Replacing the root of the tree with the next predecessor nodes/leaves in the list, while measuring/calculating the quality of the step.
(iii) In each following step, replacing each node in the tree with the next couple of predecessor nodes/leaves in the list, while measuring/calculating the quality of the step.

(c) The quality of each root/node/leaf replacement step, and/or tree level, may be evaluated, in accordance with some embodiments, by:
(i) Retrieving/receiving, for use as input, the centroid vectors and the individual feature vectors for each of the clusters (e.g. for each tree-level representing a clustering-scheme).
(ii) Utilizing a clustering evaluation metric, such as the Davies-Bouldin index or variations thereof, which favors arrangements with low cluster-internal scatter and high cluster separation, fed with the retrieved/received inputs, for evaluating the quality of each step and/or tree level.
(iii) In FIG. 5K there is shown an exemplary input set for a clustering quality evaluation, in accordance with some embodiments of the present invention, wherein the input set includes, in each input line (e.g. for each tree level) the centroid vectors and the individual feature vectors, and wherein the input-lines/tree-levels are based on exemplified results of the above, first, clustering technique/algorithm. The resulting index scores for the exemplified input set, may be: 0.444, 0.374, 0.328, 0.356. Accordingly, the selected clustering scheme/set is the third level of the tree: v₁, v₃₅, v₂₄.

(d) The confidence level for each cluster in the selected clustering scheme/set may be measured. Each cluster form the selected set may be assigned with a confidence score between 0 and 1. According to some embodiments, the confidence level of a given cluster may:
(i) Consist-of/depend-on:

(a) The count of its assigned vectors.

(b) The weights in its average vector.

(c) The distance between its two farthest vectors.

(d) The distance from the other clusters.
(ii) The following constants may be defined:

(a) W_{c}=weight given to the count of the assigned vectors

(b) W_{w}=weight given to the average value of the event vector entries

(c) W_{d}=weight given to the distnace between the two farthest vectors of the cluster

(d) W_{dc}=weight given to the distance between the cluster to its closest other cluster.
(iii) And, a resulting exemplary formula is:

W_{c}*(# of assigned vectors)+W_{w}*(average vector entry value)−W_{d}*(distance between two farthest vectors)+W_{dc}*(distance to the closest cluster) The parameters and coefficients of the exemplary formula may change or vary in different implementations.
(iv) In FIG. 5L there is shown an exemplary implementation of the above cluster confidence level measurement formula, in accordance with some embodiments of the present invention, wherein the shown formula implementation is for cluster v₂₅₃₄ of the above, first, clustering technique/algorithm.

### (C) a Profile Extension Block Including:

(1) A User Taste Profile Extension Logic may associate additional information with an existing user profile and/or with a user browsing event(s) based taste profile. According to some embodiments, demographic details about users (e.g. provided by data suppliers), details learned from text within the users web/browsing events, and/or users web/browsing event entries that are generally relevant to corresponding user profiles beyond the specific context of the event in which they appear, may be, collectively or separately, utilized for extension of user profiles. Such information may be stored in a ‘key value database/structure’/'Hash' and uploaded to a cloud storage as a part of the user profile.

(a) In the fifth input line of the input lines representing web events (FIG. 5A), for example, it may be concluded that the user has visited a football (i.e. U.S. ‘Soccer’) associated website (UEFA—Union of European Football Associations). Exemplary potential associated information may include:
(i) Such an event type (football website), may for example, suggest, with substantially high probability, that the user is a male.
(ii) In addition, for this exemplary user, ‘4c884dd5170fee471ae4e7f6303ebacb’, the data supplier may inform/indicate that he is in the age range of 35-40.
(iii) Where not prohibited by law, further useful information from the user's TV provider may be derived, such information may for example include: the size of his TV and the monthly charges he pays.

The described knowledge and information sources/types (i, ii, iii) may assist/guide further matching of specific content (e.g. an advertisement) to the user, beyond, or in addition to, the information derived from his initially generated profile. And may increase the scope, depth and/or confidence, of the knowledge about the interests of the user within specific domains or fields (e.g. entertainment).
(iv) In the present example, the extra information derived about the user includes the following data fields and associated parameters: (gender: male, age: 35-40, TV size: 42 inch, monthly bill: 16).

(2) An Event Insertion Logic may decide, upon receipt of a new event input for a given user, whether to add it to an existing cluster or to recalculate the whole tree and find the best clustering from the tree.

(a) the decision process may include:
(i) Creating a content vector for the new web/browsing event.
(ii) Finding for the created vector its closest cluster (among those in the selected tree level).
(iii) Recalculating the confidence level of the cluster.
(iv) If the reduction in the confidence level score is equal, or greater than, a predefined threshold, than the whole clustering process may be reinitiated from scratch, and a new clustering tree generated. Elsewise, the new event vector is added to its closest cluster and a new weighted average vector (centroid) for the cluster is calculated.
(v) In FIG. 5M there is shown an exemplary new web/browsing event vector insertion process result, in accordance with some embodiments of the present invention. Assuming that: a new event vector—V₆—for the user, is received; and that the formerly selected tree level for clustering, was the level including the following vector clusters (or tree nodes): V₁, V₂₅, V₃₄; the following steps are taken:
   (a) Checking which cluster is in the selected tree level is the closest one to the new V₆.
   (b) Assuming that V₃₄ is the closest cluster, and that the confidence level for it was 0.813. If the confidence of a new cluster—V₃₄₆—including V₃, V₄ and now also V₆, is greater than the threshold value in our example (i.e. 0.813*0.85) then the V₃₄₆ cluster is kept and the remaining of the clustering tree remains unchanged. If, on the other hand, the confidence of a new cluster—V₃₄₆—including V₃, V₄ and now also V₆, is lesser than the threshold value in our example (i.e. 0.813*0.85) then the entire clustering tree is recalculated.
   (c) In the figure there is shown a recalculation, in accordance with the first clustering technique/algorithm described hereinbefore, of an entire clustering tree to which V₆ has been added, and wherein the confidence level of the new cluster V₃₄₆ has been found to be lesser than the exemplary 0.813*0.85 threshold value. The calculation process may be similar to the previous ones described with the exception that the input includes vectors v₁ . . . v₆.

FIG. 4B, is a flowchart showing the steps executed as part of an exemplary process for automatic taste profiling, in accordance with some embodiments of the present invention.

According to some embodiments, a User Taste Profiling Logic may execute the following steps for automatically generating taste profiles for users associated with the data filtered and extracted from web-browsing events:

(i) Representing each relevant event as a vector of content features corresponding to the associated features (e.g. entertainment associated features) identified in the event (e.g. semantic genes of a movie or TV show).

(ii) Utilizing one or both of the following hierarchical clustering techniques:

(iii) Repetitively choosing the two closest vectors and replacing them with an average vector, (iv) until the distance between the two farthest vectors is short enough (i.e. high similarity); and/or (iii′) Repetitively dividing the set of vectors into two groups (i.e. like in a K-means algorithm with k=2), (iv′) until the diameters of all sets are at, or below, a predefined value.

(v) Storing the clustering results in a tree-like data structure, wherein the root of the tree contains the whole set of vectors and the nodes and/or leaves are the resulting clustered sub-sets.

(vi) Measuring the quality of each of the levels of the tree by a clustering evaluation metric (e.g. Davies-Bouldin index).

(vii) Finding the tree level that holds the best quality value and choosing as the user taste profile.

(viii) Determining the confidence level of each cluster by the weights of its assigned vectors, the distance between the two farthest vectors and the distance from the other clusters.

And/or (ix) Optionally extending user profiles with features such as: general surfing habits (e.g. time spent watching clips and ads), and available personal data, to enrich the amounts and/or types of information in the profiles.

FIG. 4C, is a flowchart showing the steps executed as part of an exemplary process for calculating the confidence in the matching/relevance of a web browsing event to a specific movie/TV title or another entertainment entity—based on web event URL Domain—in accordance with some embodiments of the present invention.

FIG. 4D, is a flowchart showing the steps executed as part of an exemplary process for calculating the confidence in the matching/relevance of a web browsing event to a specific movie/TV title or another entertainment entity—based on text in URL expression/page—in accordance with some embodiments of the present invention.

FIG. 4E, is a flowchart showing the steps executed as part of an exemplary process for calculating the confidence in the matching/relevance of a web browsing event to a specific movie/TV title or another entertainment entity—based on web event to genome-title/catalog-entity matching—in accordance with some embodiments of the present invention.

FIG. 4F, is a flowchart showing the steps executed as part of an exemplary process for automatic user taste profile updating, in accordance with some embodiments of the present invention.

According to some embodiments, the User Taste Profiling Logic, or a User Taste Profiling Maintenance Logic thereof, may execute the following steps for keeping the user taste profiles up to date while retaining a reasonable system workload:

(i) Monitoring for arrival of new user associated surfing/browsing events.

(ii) Receiving an arriving new event vector.

And/or (iii) Deciding whether to find for the new event vector its current place in the tree-like data structure while only modifying its own respective cluster, or whether to recalculate the whole set of clusters.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A System for matching web events to records in a Catalog or Data-Store listing content titles or entities in a specific domain (e.g. entertainment), said system comprising:
a User Events Analysis Server communicatively associated with a web server for extracting from one or more web event lines, representing web activities of specific users and received from the web server, sets of linguistic items potentially associated with the specific domain (e.g. entertainment) and registering the linguistic items sets to a Keywords/Phrases Data Storage; and
a User Semantic Taste Profiling Server communicatively associated with said Keywords/Phrases Data Storage and with said Catalog or Data-Store, said Profiling Server including an Event Matching Logic for retrieving from said Keywords/Phrases Data Storage and matching, at least some of the extracted linguistic items sets, to records (e.g. entertainment titles) in said Catalog or Data-Store, wherein the relative level of confidence in the matching of a given linguistic items set to one or more given records (e.g. entertainment title(s)) is at least partially based on a combination of the following measures of relevance: (a) the matching success history of the given web-domain, which is the source of the linguistic items set currently being matched, (b) positive or negative clues in the text of the URL expression, or the URL linked webpage, associated with the web event from which the linguistic items set, currently being matched, was extracted and, (c) one or more characteristics of candidate titles or entities to which the linguistic items set is currently being matched.

2. The system according to claim 1, wherein said Event Matching Logic is further adapted for:
allocating an initial score to each web-domain associated with a web event line from which a linguistic items set has been extracted;
upon a successful matching of a linguistic items set to a specific record (e.g. entertainment title) in said Catalog or Data-store, increasing the score of the web-domain associated with the web event line from which the successfully matched linguistic items set has been extracted; and
estimating the relative confidence, in the matching of at least a following linguistic items set to specific records (e.g. entertainment titles) in said Catalog or Data-store, at least partially based on an increased score of the web-domain associated with the web event line from which the following set(s) of linguistic items has been extracted.

3. The system according to claim 1, wherein said Event Matching Logic is further adapted for:
allocating an initial weight to specific linguistic items extracted from the URL string address, or the text within the URL linked webpage, of logged web event lines;
upon a successful matching of a linguistic items set to a specific record (e.g. entertainment title) in said Catalog or Data-store, tuning up the weight(s) of at least some of the specific linguistic items in the set that participated in the successful matching; and
estimating the relative confidence, in the matching of at least a following linguistic items set to specific records (e.g. entertainment titles) in said Catalog or Data-store, at least partially based on the tuned up weights of the linguistic items within the following set.

4. The system according to claim 3, wherein as part of tuning up the weight(s) of at least some of the specific linguistic items that participated in the successful matching, said Event Matching Logic is further adapted for:
setting a similar initial delta value for each of the extracted linguistic items; and
upon a successful matching of a linguistic items set to a specific record (e.g. entertainment titles) in said Catalog or Data-store:
(a) adding, to the current weight of at least one specific linguistic item that participated in the successful matching, the multiplication of its delta value by its current weight and (b) updating the delta value of the specific linguistic item that participated in the successful matching, by multiplying it by a pre-defined coefficient.

5. The system according to claim 1, wherein said Event Matching Logic is further adapted for estimating the relative confidence, in the matching of a linguistic items set to specific records (e.g. entertainment titles) in said Catalog or Data-store, at least partially based on one or more semantic content characteristics of a specific title or entity record to which the linguistic items set is being matched.

6. The system according to claim 5, wherein the semantic content characteristics of a specific record, to which the linguistic items set is being matched, are selected from the group consisting of: (a) the length of the matched record, wherein the more words, or characters, are in the record name, the higher the relative confidence in the matching is, (b) the popularity and age of the matched record, wherein the more popular and/or recent a given record is, the higher the relative confidence in the matching is and (c) the statistical term frequencies of the matched record, wherein the lower is the likelihood of the record to be referred to other than as a record in the specific domain, the higher the relative confidence in the matching is.

7. The system according to claim 6, wherein said Event Matching Logic is further adapted for:
calculating the likelihood of the record to be referred to other than as a record in the specific domain by:
performing a first set of one or more search engine queries, wherein both the record and linguistic items in the specific domain are included in the query;
performing a second set of one or more search engine queries, wherein the record with no linguistic items in the specific domain, or the record and linguistic items in a domain(s) other than the specific domain, are included in the query; and
calculating a ratio between the average number of search results yielded for the first set of queries and the average number of search results yielded for the second set of queries, wherein the lower the value of the calculated ratio is, the higher likelihood of the record to be referred to other than as a record in the specific domain.

8. The system according to claim 7, wherein said Event Matching Logic is further adapted for:
repeating the likelihood calculation for at least an additional record; and
selecting a subset of records, having the highest relative likelihood of being referred to as a record in the specific domain.

9. The system according to claim 1, wherein said User Events Analysis Server further includes an Event Files Keywords/Phrases Growth Algorithm for utilizing content matching techniques to respectively search and find, for each of some or all of the generated linguistic items sets, web-locations containing linguistic items already found in each of the sets; and for adding to the linguistic items already found in each of the generated sets, additional corresponding linguistic items which appear on the found web-locations associated with each the sets.

10. The system according to claim 1, wherein said User Semantic Taste Profiling Server is adapted for dynamically calculating one or more values based on records (e.g. entertainment titles) in said Catalog or Data-Store; and wherein matching at least some of the extracted linguistic items sets to records (e.g. entertainment titles) in said Catalog or Data-Store, at least partially includes the matching of the extracted linguistic items sets to the dynamically calculated values.

11. A System for generating user semantic taste profiles, said system comprising:
a User Semantic Taste Profiling Server communicatively associated with: a Keywords/Phrases Data Storage containing web event extracted linguistic items sets which are potentially associated with a specific domain (e.g. entertainment), a records Catalog or Data-store listing content titles or entities in the specific domain and, a Structured Taxonomy of degreed semantic features associated with records in the specific domain, said Profiling Server including: (a) an Event Matching Logic for retrieving from said Keywords/Phrases Data Storage and matching, at least some of the extracted linguistic items sets, to records (e.g. entertainment titles) in said Catalog or Data-store; (b) an Event Vectors Generator for generating a vector, for each matched web event, wherein at least some of the value-entries in the generated vector are values of domain-specific degreed semantic features retrieved from said Structured Taxonomy, based on one or more successfully matched Catalog or Data-store records (e.g. entertainment title); (c) a Clustering Logic for populating a tree structured database with two or more generated vectors associated with the same specific user, wherein each level of the tree, represents a different clustering structure of the specific user associated vectors; and (d) a Clustering Results Confidence Measuring Logic for selecting an optimal clustering level of the tree structure as a representation of the semantic taste profile of the specific user, wherein each cluster of vector(s) within the selected clustering level represents a different semantic taste of the specific user.

12. The system according to claim 11, wherein said Clustering Logic is further adapted, as part of populating a tree structured database with vectors, for: (a) receiving as input a set of event vectors and registering each of the vectors as a leaf in the tree structured database; (b) in each of a set of steps/iterations merging a pair of the most shortly distanced vectors into a single vector, wherein the merged vector consists of a weighted average of its source vectors, and storing the merged vector along with its creation time, and copies of the non-merged vectors, one tree level closer to the root of the tree structured database; and (c) halting the populating of the tree structured database once the distance between the two closest vectors is equal to, or greater than, a predetermined threshold value.

13. The system according to claim 12, wherein said Clustering Results Confidence Measuring Logic is further adapted, as part of selecting an optimal clustering level of the tree structure, for: (a) retrieving or receiving as input, centroid vectors and individual feature vectors, for each of the clusters, of each of the tree structure levels representing a different clustering structure of the specific user associated vectors;
(b) utilizing a clustering evaluation metric which favors arrangements with low cluster-internal scatter and high cluster separation, fed with the retrieved or received inputs, for evaluating the quality of each tree level; and (c) selecting the tree structure level having the highest evaluated quality as the representation of the semantic taste profile of the specific user.

14. The system according to claim 11, wherein said Clustering Logic is further adapted, as part of populating a tree structured database with vectors, for: (a) receiving as input a set of event vectors and registering all vectors in the input set, as a single cluster, to the root of the tree structured database;
(b) in each of a set of steps/iterations splitting the cluster into two different clusters, and storing the split vectors, along with their creation times, one tree level further away from the root of the tree structure; and (c) halting the populating the tree structured database once the diameter (i.e. distance between vectors in a given cluster) of all vectors clusters, is equal to, or smaller than, a predetermined threshold value.

15. The system according to claim 14, wherein said Clustering Logic is further adapted, as part of splitting a vectors cluster into two different clusters, to apply a K-means algorithm with k=2.

16. The system according to claim 14, wherein said Clustering Results Confidence Measuring Logic is further adapted, as part of selecting an optimal clustering level of the tree structure, for: (a) retrieving or receiving as input, centroid vectors and individual feature vectors, for each of the clusters, of each of the tree structure levels representing a different clustering structure of the specific user associated vectors;
(b) utilizing a clustering algorithms evaluation scheme, fed with the retrieved or received inputs, for evaluating the quality of each tree level; and (c) selecting the tree structure level having the highest evaluated quality as the representation of the semantic taste profile of the specific user.

17. The system according to claim 11, wherein said Event Vectors Generator is further adapted for including in at least some of the vectors generated for each matched web event, value-entries representing non-taste relating features.

18. The system according to claim 17, wherein non-taste relating features are selected from a group consisting of: values representing web-surfing habits and available personal data.
